(19) United States
(12) Patent Application Publication
(10) Pub. No.: US 2026/0122061 A1
(43) Pub. Date: Apr. 30, 2026

(54) DIGITAL SERVICE AUTHENTICATION USING A CONTACTLESS CARD

(71) Applicant: Capital One Services, LLC, McLean, VA (US)

(72) Inventors: Jaikishan Prasad, Arlington, VA (US); Kevin Osborn, Newton Highlands, MA (US)

(73) Assignee: Capital One Services, LLC, McLean, VA (US)

(21) Appl. No.: 18/929,816

(22) Filed: Oct. 29, 2024

(51) Int. Cl. H04L 9/40

(52) U.S. Cl. CPC H04L 63/0853; H04L 63/083

(57) ABSTRACT

A method, a system, a device, and a computer program product for executing authentication. A user login information associated with using at least one digital service in a plurality of digital services is authenticated. Authentication includes verifying the user login information with at least one digital service, and storing the verified user login information. A cryptogram including the verified user login information is generated. The generated cryptogram including the verified user login information is provided to a contactless card communicatively coupled to at least one processor, causing the generated cryptogram to be stored in a memory location of the contactless card. The generated cryptogram is configured to automatically authenticate the user login information for accessing at least one digital service using the contactless card.

### TECHNICAL FIELD

This disclosure relates generally to data processing and, in particular, to using contactless cards for authentication purposes in connection with digital services.

### BACKGROUND

Contactless card products have become so universally well-known and ubiquitous that they have fundamentally changed the manner in which financial transactions and dealings are viewed and conducted in society today. Contactless card products are most commonly represented by plastic or metal card-like members that are offered and provided to customers through credit card issuers (such as banks and other financial institutions). With a card, an authorized customer or cardholder is capable of purchasing services and/or merchandise without an immediate, direct exchange of cash. Data security and transaction integrity are of critical importance to businesses facilitating these transactions and to the customers. This need continues to grow as electronic transactions performed with contactless cards constitute an increasingly large share of commercial activity. Accordingly, there is a need to provide businesses and users with an appropriate solution that overcomes current deficiencies to provide data security, authentication, and verification for contactless card.

Further, contactless card tapping transactions have become some of the most popular ways of paying for goods and services. This technology is based on radio-frequency identification (RFID) components embedded into credit cards, smartphones, etc. to allow users to make various transactions (e.g., purchases, fund withdrawals, etc.) by bringing their cards and/or smartphones within a specific distance of (or tapping on) specific areas of terminals, which enables transfer of certain data for the purposes of a transaction. However, existing card tapping technology does not allow for automatic authentication of card users for the purposes of accessing different digital services (e.g., shopping, banking, etc.).

### SUMMARY

In some implementations, the current subject matter relates to a computer implemented method. The method may include authenticating, using at least one processor, a user login information associated with using at least one digital service in a plurality of digital services, the authenticating including verifying the user login information with at least one digital service, and storing the verified user login information. The method may also include generating a cryptogram including the verified user login information, and providing the generated cryptogram including the verified user login information to a contactless card communicatively coupled to at least one processor, and causing the generated cryptogram to be stored in a memory location of the contactless card. The generated cryptogram is configured to automatically authenticate the user login information for accessing the at least one digital service using the contactless card.

In some implementations, the current subject matter may include one or more of the following optional features. The generated cryptogram may be configured to include a plurality of user login information. Each user login information in the plurality of user login information may be associated with a respective digital service in the plurality of digital services.

In some implementations, the method may also include generating an updated cryptogram, the updated cryptogram including at least one of the following: a verified updated user login information associated with the at least one digital service, another verified user login information associated with at least another digital service in the plurality of digital services, and any combination thereof, and providing the updated cryptogram to the contactless card and causing the updated cryptogram to be stored in the memory location of the contactless card.

In some implementations, verifying may include verifying the user login information using at least one of: a multi-factor authentication, a biometric information of the user associated with the login information, and any combination thereof.

In some implementations, the method may also include selecting at least one digital service for accessing, generating a user interface associated with the selected at least one digital service, receiving, via the generated user interface, the user login information associated with at least one digital service, transmitting the received user login information to the at least one digital service, and executing the authenticating of the user login information.

In some implementations, the method may further include receiving the stored verified user login information from the contactless card, and automatically accessing at least one digital service using the stored verified user login information. Automatically accessing may include generating a digital service user interface associated with at least one digital service while bypassing the authenticating, where the digital service user interface may be configured to enable access to one or more secure digital services associated with at least one digital service.

In some implementations, at least one digital service may include at least one of the following: a website, a mobile application, and any combination thereof.

In some implementations, the current subject matter relates to a contactless card. The contactless card may include at least one processor, and at least one non-transitory storage media storing instructions, that when executed by at least one processor, cause at least one processor to perform operations including receiving and storing a cryptogram, the cryptogram including a verified user login information, the verified user login information being generated by authenticating a user login information associated with using at least one digital service in a plurality of digital services and by verifying the user login information with the at least one digital service; and automatically authenticating, using the cryptogram, the user login information for accessing the at least one digital service.

In some implementations, the current subject matter may include one or more of the following optional features. The generated cryptogram may be configured to include a plurality of user login information, each user login information in the plurality of user login information being associated with a respective digital service in the plurality of digital services.

In some implementations, the operations may further include receiving and storing an updated cryptogram, the updated cryptogram including at least one of the following: a verified updated user login information associated with at least one digital service, another verified user login information associated with at least another digital service in the plurality of digital services, and any combination thereof; and automatically authenticating, using the updated cryptogram, the user login information for accessing at least one digital service.

In some implementations, verifying may include verifying the user login information using at least one of: a multi-factor authentication, a biometric information of the user associated with the login information, and any combination thereof.

In some implementations, the operations may further include receiving a selection of at least one digital service for accessing; causing generation of a user interface associated with the selected at least one digital service; identifying the stored verified updated user login information associated with the selected at least one digital service; transmitting the identified stored verified user login information; and causing automatic access to at least one digital service using the stored verified user login information. Causing of the automatic accessing may include triggering generation of a digital service user interface associated with the at least one digital service while bypassing the authenticating, wherein the digital service user interface is configured to enable access to one or more secure digital services associated with at least one digital service.

In some implementations, at least one digital service may include at least one of the following: a website, a mobile application, and any combination thereof.

In some implementations, the current subject matter relates to a system. The system may include a contactless card, at least one processor communicatively coupled to the contactless card, and at least one non-transitory storage media storing instructions, that when executed by at least one processor, cause at least one processor to perform operations including selecting at least one digital service for accessing; generating a user interface associated with selected at least one digital service; receiving, via the generated user interface, a user login information associated with at least one digital service; transmitting the received user login information to at least one digital service; authenticating the received user login information associated by verifying the received user login information with at least one digital service, and storing the verified user login information; generating a cryptogram including the verified user login information; and providing the generated cryptogram including the verified user login information to the contactless card, and causing the generated cryptogram to be stored in a memory location of the contactless card; automatically authenticating, using the contactless card, the user login information for accessing the at least one digital service using the contactless card.

In some implementations, the current subject matter may include one or more of the following optional features. The generated cryptogram may be configured to include a plurality of user login information, each user login information in the plurality of user login information being associated with a respective digital service in the plurality of digital services.

In some implementations, verifying may include verifying the user login information using at least one of: a multi-factor authentication, a biometric information of the user associated with the login information, and any combination thereof.

In some implementations, the operations may include receiving a selection of at least one digital service for accessing; causing generation of a user interface associated with the selected at least one digital service; identifying the stored verified updated user login information associated with the selected at least one digital service; transmitting the identified stored verified user login information; and causing automatic access to the at least one digital service using the stored verified user login information by triggering generation of a digital service user interface associated with at least one digital service while bypassing the authenticating, where the digital service user interface is configured to enable access to one or more secure digital services associated with at least one digital service.

In some implementations, at least one digital service may include at least one of the following: a website, a mobile application, and any combination thereof.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A illustrates an example system for authenticating a user in connection with accessing one or more desired digital services, according to some implementations of the current subject matter.

FIG. 1B illustrates further details on the system shown in FIG. 1A.

FIG. 2 illustrates an example method for authenticating a user in connection with accessing one or more desired digital services, according to some implementations of the current subject matter.

FIG. 3 illustrates an example method for authenticating a user in connection with accessing one or more desired digital services, according to some implementations of the current subject matter.

FIG. 4 illustrates another example method for authenticating a user in connection with accessing one or more desired digital services, according to some implementations of the current subject matter.

FIG. 5 illustrates another example method for authenticating a user in connection with accessing one or more desired digital services, according to some implementations of the current subject matter.

FIG. 6 illustrates an aspect of the subject matter in accordance with one embodiment.

FIG. 7 illustrates a contactless card in accordance with one embodiment.

FIG. 8 illustrates a transaction card component in accordance with one embodiment.

FIG. 9 illustrates a sequence flow in accordance with one embodiment.

FIG. 10 illustrates an example of a system configured to operate in accordance with embodiments discussed herein.

FIG. 11 illustrates an aspect of the subject matter in accordance with one embodiment.

FIG. 12A illustrates an aspect of the subject matter in accordance with one embodiment.

FIG. 12B illustrates an aspect of the subject matter in accordance with one embodiment.

FIG. 12C illustrates an aspect of the subject matter in accordance with one embodiment.

FIG. 13 illustrates an aspect of the subject matter in accordance with one embodiment.

FIG. 14 is a flow chart illustrating various operations of an example method in accordance with one embodiment.

FIG. 15 illustrates an aspect of the subject matter in accordance with one embodiment.

FIG. 16 illustrates an aspect of the subject matter in accordance with one embodiment.

### DETAILED DESCRIPTION

To address these and potentially other deficiencies of currently available solutions, one or more implementations of the current subject matter relate to methods, systems, articles of manufacture, and the like that can, among other possible advantages, provide use of contactless cards for authenticating access to digital services.

In some implementations, the current subject matter generally relates to using a contactless card as a single point of access to multiple digital services, e.g., shopping websites, banking websites, etc. To create such point of access, a user may first login into each digital service through a mobile application (e.g., a mobile application associated with a financial institution that issued the card). Once the login has been authenticated/verified, the mobile application may be configured to generate a cryptogram that may include a login information for each digital service that the user may wish to use. The cryptogram may be stored on a mobile device and/or on the contactless card. If the user wishes to access a particular digital service, the user may use the contactless card (e.g., by tapping the contactless card on a mobile device and/or bringing the contactless card in the vicinity of the mobile device, etc.) to open the mobile application on the mobile device. The application may then automatically authenticate the user with the desired digital service, using the login credentials that are stored on the contactless card, and thereby, provide the user with access to the digital service. One of the advantages of the current subject matter is that it provides a centralized location (e.g., a contactless card) using which the user is able to access multiple digital services without the need to memorize access information (e.g., login, password, etc.) for each such service and/or use separate tokens (e.g., multi-factor authentication token, etc.) for authentication. Such access may be enabled through use of tapping technology associated with contactless cards, which may be used with one or more mobile applications being executed on a mobile device.

In some implementations, as stated above, the user's mobile device may be configured to include a mobile application that may be executed and/or running on the mobile device. The mobile application may be associated with a financial institution that may have issued a contactless card to the user. The user may also have a financial account associated with the financial institution. The account may also be linked to the contactless card. The contactless card may be provided to the user in an un-activated and/or inactive form and may be activated using the mobile application running on user's mobile device. Activation of the contactless card may be accomplished using the tapping technology and/or by bringing the contactless card within a predetermined distance and/or area away from the mobile device. This allows the contactless card and the mobile device to establish a near-field communication (NFC) exchange link, using which, the contactless card and the mobile device may exchange various information/data for activation, authentication, transaction processing, and/or any other purposes.

The user may use the mobile application to identify one or more digital services that the user would like use for any desired purposes (e.g., banking, shopping, funds transfer, secure transactions, etc.). The digital services may require the user to provider user authentication credentials (e.g., username and password, etc.) prior to use of their secure services. Each digital service may require its own user authentication credentials.

Once the digital service is selected by the user, the mobile application may be configured to execute one or more application programming interfaces (APIs) to connect to one or more servers associated with the digital service and generate one or more graphical user interfaces. The user may use the graphical user interface to provide user's login information for the selected digital services. Alternatively, or in addition, when the API(s) connect to the digital service's server(s), the server(s) may be configured to transmit an indication (e.g., code, etc.) that may cause the mobile device to generate the graphical user interface either within the mobile application associated with the financial institution and/or open a separate application that may prompt the user to enter user's login information for that digital service. The separate application may, for example, be a browser, a pop-up, etc. that may be configured to connect and open a web page associated with the digital service. The web page may include one or more fields for user's entry of the user's login information. Once the user's login information is provided via the mobile device, the mobile device may be configured to transmit the login information to the digital service's server for authentication.

Upon authentication of the user's login information, the digital service's server may transmit an appropriate indication to the mobile device. The mobile application (running on the mobile device) may be configured to encrypt and/or store the authenticated user's login information on the mobile device and/or transmit it to the contactless card for storage thereon. In some example, non-limiting implementations, the user's authentication information, e.g., a password, may, optionally, be hashed prior to transmission. The mobile device and/or the contactless card may be configured to store the authenticated user's login information for the digital service in any desired form and/or location. Moreover, the mobile device and/or the contactless card may be configured to store multiple authenticated user's login information for a plurality of digital services. Each such login information may be identified using a unique identifier, which may be used to retrieve the login information when access to a specific digital service is desired.

If the digital service's server is unable to authenticate the user's login information, the mobile device may be configured to receive an error message from the server to that effect. The mobile application may then prompt the user to enter the login information again and/or request that the user perform any other action (e.g., contact customer service, try entering login information again, etc.). Storage of login information that has not been authenticated on the mobile device and the contactless card may be prevented.

To use the stored login information (either stored on the mobile device and/or the contactless card) to access a desired digital service, an application, a website, an interface, etc. for that digital service may be accessed, opened, etc. The contactless card may then be tapped on the mobile device. The mobile device may then access the stored login information and populate appropriate login information fields for the digital service's application, website, interface, etc. If the login information is being retrieved from the contactless card, the mobile device may be configured to transmit a request to the contactless card identifying the specific digital service for which login information is desired. The contactless card may then respond, e.g., using a cryptogram containing the requested login information, to the mobile device by transmitting the login information. The mobile device may receive the cryptogram and extract the login information in order to populate the login information fields on the digital service's application, website, interface, etc. If the login information is being retrieved from the mobile device's memory, the mobile device may issue an appropriate query to its storage/memory and retrieve the login information.

In some implementations, for enhanced security purposes, the user may also be requested, e.g., by the mobile device, to provide user's biometric data (e.g., a fingerprint, a facial identification, etc.), a passcode, a pin, etc. so that the mobile device may access the stored login information, either stored on the mobile device and/or on the contactless card. Alternatively, or in addition, the biometric data may be requested after retrieval but prior to populating login information fields on the digital service's application, website, interface, etc. This may mean that the stored login information may be encrypted with the user's biometric data for additional security. Alternatively, or in addition, biometric data may be stored on the contactless card, where the mobile device, via an application, may provide biometric data for comparison and/or evaluation by the contactless card. If the contactless card determines that there is a match (e.g., validates the received biometric data) between the stored biometric data and one provided by the mobile device, the contactless card may release its stored biometric data to the mobile device. Once the biometric data is received, the mobile device may be configured to compare the received biometric data with the stored biometric data (alternatively, or in addition, the mobile device may be configured to transmit the received biometric data to an external server for comparison, and/or validated the biometric data in any other desired way). If a match is detected, the login information may be released for populating login fields of the digital service's application, website, interface, etc. Otherwise, release of the login information may be blocked (e.g., by the mobile device, external server, etc.).

In some implementations, the data for storage on the contactless card may be encrypted (e.g., using any desired encryption protocols) using one or more external computing components, e.g., a server, a mobile device, and/or any other computing component. Alternatively, or in addition, such data may be encrypted by the contactless card. The encrypted data stored on the contactless card may be decrypted by one or more of such external computing components, once appropriate authentication/validation processes are performed, e.g., user's credentials (e.g., biometric data, passcode, login, pin, etc.) are authenticated, validated, etc. Alternatively, or in addition, the contactless card may decrypt stored information upon authenticating/validating appropriate user credentials. In some example implementations, encryption and/or decryption may be accomplished using a single tap, e.g., assuming the contactless card is performing the encryption and/or decryption. Multiple taps may likewise be used, such as, for instance, one tap for contactless card authentication and another tap for selection of an encryption key (and/or decryption key) for encryption (and/or decryption) of data by one or more external computing components.

In some instances, contactless card functions discussed herein may be utilized in a multi-issuer computing environment. These functions may include tap-to functions where a user may tap their contactless card on a device, such as a mobile device, to perform a function. For example, a user may utilize their contactless card to verify their identity, perform a payment, launch applications, log into applications, autofill a form or field, navigate to a specified web location or app on a device, unlock a door, initiate a contactless card, verify themselves, and so forth.

The systems discussed here may enable users to perform these functions in a multi-issuer environment. Further, the systems discussed herein enable card issuers or payment providers, such as banks, to issue contactless cards with tap-to functions to customers while maintaining high-level security. The systems discussed differ from previous solutions because they provide a single platform for multiple issuers to provide the tap-to functionality. Traditionally, each issuer must set up and maintain its own systems to provide contactless card features. This includes maintaining their own hardware, software, databases, security protocols, and so forth, which can become extremely costly for the issuer to maintain. However, the embodiments discussed enable issuers to offload much of the processing, storage, and security functionality to a neutral or central system. As will be discussed in more detail, the central system is configured to provide contactless card features for multiple issuers while maintaining high security and data integrity. Each issuer's functionality and data may be separately managed and secured such that another issuer cannot access another issuer's data or functions. As will be discussed in more detail, these features may be provided by a switchboard system configured to process and perform each contactless card function securely. Additional benefits for issuers may include providing a highly secure authentication option for mobile web, which typically lacks the robust authentication options available in a native application.

Further, embodiments discussed herein support tap-to mobile web experiences on both major mobile platforms (iOS®, Android®) by leveraging App Clips® and Javascript® SDK with WebNFC®. For iOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apple's® App Store.

In the Android® operating system environment, embodiments include utilizing a JavaScript SDK. The JavaScript SDK may be installed into a website e.g., via source code. The JavaScript SDK also includes functions to support NFC communications between mobile devices and contactless cards via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner, and UI libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

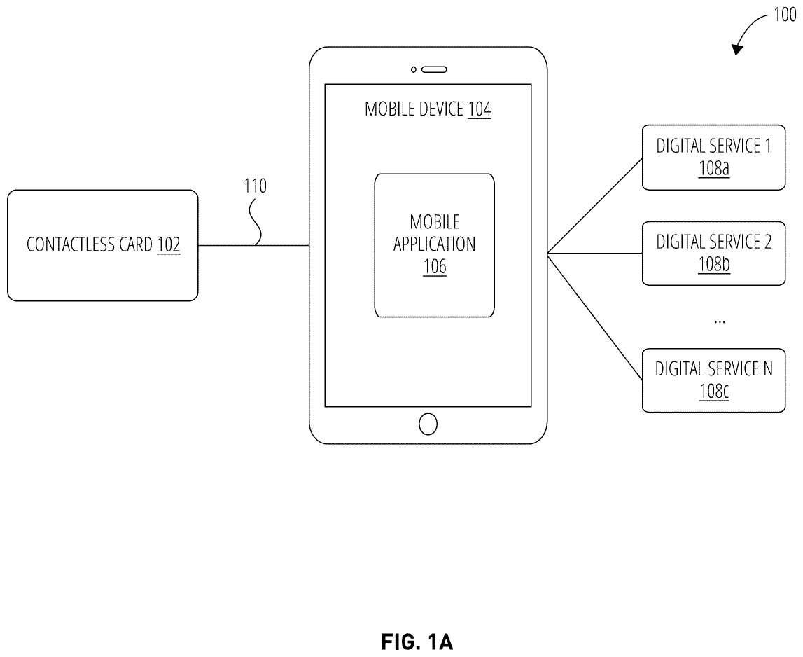

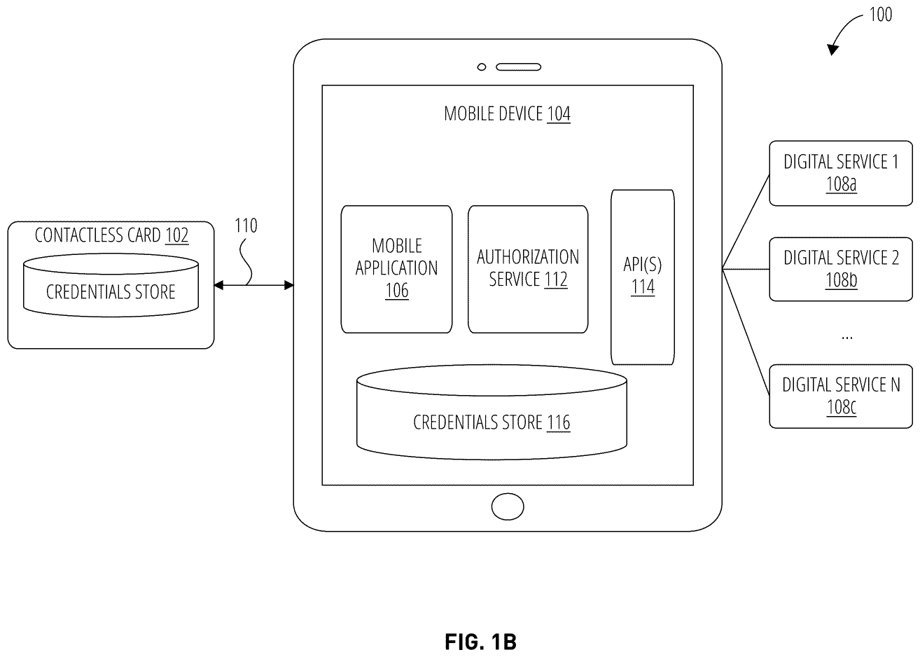

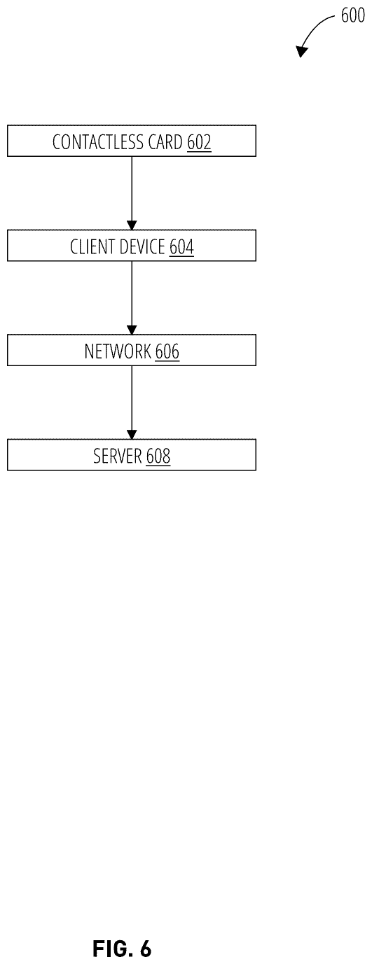

FIGS. 1A-B illustrate an exemplary system 100 for authenticating a user in connection with accessing one or more desired digital services, according to some implementations of the current subject matter. The system 100 may include a contactless card 102, a mobile device 104 having one or more mobile applications 106, and one or more digital services 1, 2, . . . , n 108 (a, b, . . . , c). The contactless card 102 may have one or more features discussed below in connection with FIGS. 6-16.

The mobile device 104 may be configured to have a predetermined area that may be configured to surround the mobile device 104. The mobile device 104 may be configured to detect one or more objects, such as, the contactless card 102, upon entry of an object into such predetermined area. Alternatively, or in addition, the mobile device 104 may be configured to detect an object upon the object being positioned within a predetermined distance away from the mobile device 104.

One or more components of the system 100 may include any combination of hardware and/or software. In some implementations, one or more components of the system 100 may be disposed on one or more computing devices, such as, server(s), database(s), personal computer(s), laptop(s), cellular telephone(s), smartphone(s), tablet computer(s), virtual reality devices, and/or any other computing devices and/or any combination thereof. In some example implementations, one or more components of the system 100 may be disposed on a single computing device and/or may be part of a single communications network. Alternatively, or in addition to, such services may be separately located from one another. A service may be a computing processor, a memory, a software functionality, a routine, a procedure, a call, and/or any combination thereof that may be configured to execute a particular function associated with the current subject matter lifecycle orchestration service(s).

In some implementations, the system 100's one or more components may include network-enabled computers. As referred to herein, a network-enabled computer may include, but is not limited to a computer device, or communications device including, e.g., a server, a network appliance, a personal computer, a workstation, a phone, a smartphone, a handheld PC, a personal digital assistant, a thin client, a fat client, an Internet browser, or other device. One or more components of the system 100 also may be mobile computing devices, for example, an iPhone, iPod, iPad from Apple® and/or any other suitable device running Apple's iOS® operating system, any device running Microsoft's Windows®. Mobile operating system, any device running Google's Android® operating system, and/or any other suitable mobile computing device, such as a smartphone, a tablet, or like wearable mobile device.

One or more components of the system 100 may include a processor and a memory, and it is understood that the processing circuitry may contain additional components, including processors, memories, error and parity/CRC checkers, data encoders, anti-collision algorithms, controllers, command decoders, security primitives and tamper-proofing hardware, as necessary to perform the functions described herein. One or more components of the environment 100 may further include one or more displays and/or one or more input devices. The displays may be any type of devices for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touchscreen, keyboard, mouse, cursor-control device, touchscreen, microphone, digital camera, video recorder or camcorder. These devices may be used to enter information and interact with the software and other devices described herein.

In some example implementations, one or more components of the environment 100 may execute one or more applications, such as software applications, that enable, for example, network communications with one or more components of environment 100 and transmit and/or receive data.

One or more components of the environment 100 may include and/or be in communication with one or more servers via one or more networks and may operate as a respective front-end to back-end pair with one or more servers. One or more components of the environment 100 may transmit, for example from a mobile device application (e.g., executing on one or more user devices, components, etc.), one or more requests to one or more servers. The requests may be associated with retrieving data from servers. The servers may receive the requests from the components of the system 100. Based on the requests, servers may be configured to retrieve the requested data from one or more databases. Based on receipt of the requested data from the databases, the servers may be configured to transmit the received data to one or more components of the system 100, where the received data may be responsive to one or more requests.

The system 100 may include one or more networks. In some implementations, networks may be one or more of a wireless network, a wired network or any combination of wireless network and wired network and may be configured to connect the components of the system 100 and/or the components of the system 100 to one or more servers. For example, the networks may include one or more of a fiber optics network, a passive optical network, a cable network, an Internet network, a satellite network, a wireless local area network (LAN), a metropolitan area network (MAN), a wide area network (WAN), a virtual local area network (VLAN), an extranet, an intranet, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or any other type of network and/or any combination thereof.

In addition, the networks may include, without limitation, telephone lines, fiber optics, IEEE Ethernet 802.3, a wide area network, a wireless personal area network, a LAN, or a global network such as the Internet. Further, the networks may support an Internet network, a wireless communication network, a cellular network, or the like, or any combination thereof. The networks may further include one network, or any number of the exemplary types of networks mentioned above, operating as a stand-alone network or in cooperation with each other. The networks may utilize one or more protocols of one or more network elements to which they are communicatively coupled. The networks may translate to or from other protocols to one or more protocols of network devices. The networks may include a plurality of interconnected networks, such as, for example, the Internet, a service provider's network, a cable television network, corporate networks, such as credit card association networks, and home networks.

The system 100 may include one or more servers, which may include one or more processors that may be coupled to memory. Servers may be configured as a central system, server or platform to control and call various data at different times to execute a plurality of workflow actions. Servers may be configured to connect to the one or more databases. Servers may be incorporated into and/or communicatively coupled to at least one of the components of the system 100.

One or more components of the system 100 may be configured to execute one or more transactions using one or more containers. In some implementations, each transaction may be executed using its own container. A container may refer to a standard unit of software that may be configured to include the code that may be needed to execute the action along with all its dependencies. This may allow execution of actions to run quickly and reliably.

In some implementations, as discussed above, the system 100 may be used for authenticating user's login information to various digital services 108 as well as using such authenticated user's login information to access secure areas of selected digital services 108 using the contactless card 102. In particular, the transactions may be executed using near-field communications (NFC) exchange link 110 between the contactless card 102 and the mobile device 104. To enable use of the NFC technology, the contactless card 102 may be brought within the predetermined area/distance of the mobile device 104 (e.g., by tapping the card 102 on the mobile device 104) to cause the mobile device 104 to detect presence of the contactless card 102 and execute one or more operations discussed herein. In the NFC exchange link 110, the mobile device 104 may be configured to act as an active component and provide power to energize the contactless card 102 (as discussed herein), which may be a passive component. Using the link 110, the mobile device 104 and the contactless card 102 may be configured to exchange various data, e.g., transmission of authenticated user's login information to and/or from the contactless card 102 for the purposes of accessing one or more secure areas of a selected digital service 108, etc.

The mobile device 104 may also be securely linked to a financial account (not shown in FIG. 1A) at a financial institution that may be associated with the contactless card 102. Access to the account from the mobile device 104 may be secured/protected using various authentication/authorization mechanisms (e.g., username and password, user biometrics, passcodes, multi-factor authentication tokens, etc.). Such protection may also be used to secure user's login information that may be used to access one or more digital services 108.

Further, the NFC link 110 may be used by the contactless card 102 and the mobile device 104 to exchange various identification data from the contactless card 102 along with user's login information associated with one or more digital services 108. The identification data may include various information identifying the card 102 and/or the user of the card (e.g., one or more identifiers, etc.). The contactless card 102 may be configured to transmit contactless card data that may be stored on the card. Examples of the contactless card data may include an account number associated with the contactless card, an expiration date associated with the contactless card, a card verification value (CVV) associated with the contactless card, a billing address associated with the contactless card, a name of a user associated with the contactless card, etc.

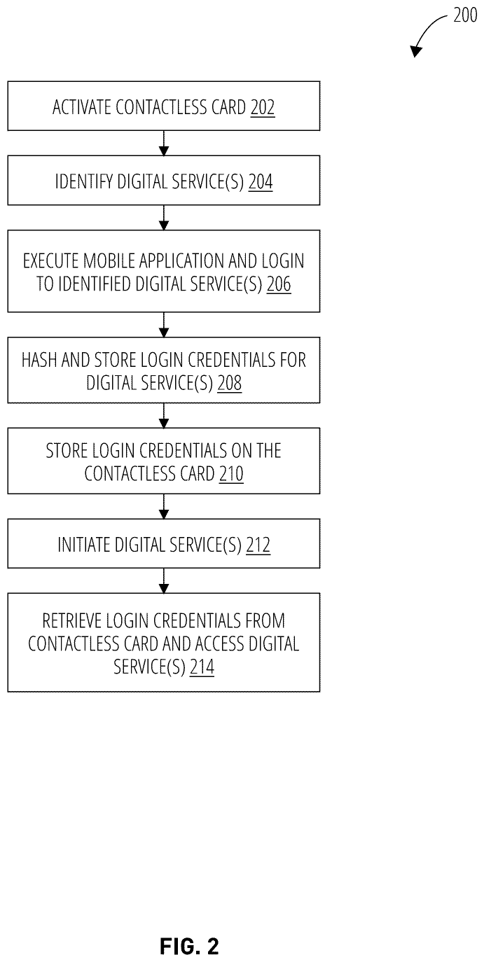

Referring to FIG. 1B, which provides additional details of the system 100 shown in FIG. 1A, as well as FIG. 2, which illustrates an example method 200 that may be executed by the system 100, the contactless card 102 may be activated, at 202, (e.g., using any desired methods) for example (among other) purposes of using it to access one or more digital services 108, as shown in FIG. 1B. The contactless card 102 may be used in conjunction with the mobile device 104, which may be configured to execute one or more mobile applications 106 and/or authentication service(s) 112. The mobile device 104 may also include one or more storage locations 116, which may be used for storing of one or more authenticated user's login information (e.g., credentials) for accessing one or more digital services 108.

In some implementations, the mobile application 106 may be used to identify and/or select, at 204 (as shown in FIG. 2), one or more digital services 108 that the user would like to use. The identification and/or selection of digital services 108 may be performed by opening applications, user interfaces, selecting of digital service icons on the mobile device's 104 user interface, and/or performed in any other desired way. The services 108 may be in any area, e.g., shopping, video streaming, financial transactions, etc. One or more of the digital services 108 may be configured to require providing of user login information or credentials (e.g., login, password, etc.) before accessing secure information related to the services and/or user. Such login information may be used to protect sensitive information, ensure that only an authorized user us using the services, etc. As can be understood, each digital service 108 may be associated with a separate user login information.

After selecting a particular digital service 108, the mobile application 106, which may be executed on the mobile device 104, at 206, may be configured to execute one or more application programming interfaces (APIs) 114. In some implementations, a separate API 114 may be configured to be executed for each selected digital service 108. Alternatively, or in addition, a single API 114 may be executed for all services 108. The API 114 may be used for connection to the selected digital service 108 (e.g., its servers, networks, etc.). Once connection is established, the mobile application 106 may be configured to generate one or more graphical user interfaces, which may include one or more fillable fields for entry of user's login information associated with the selected digital service 108. The user's login information may be received by the mobile application 106, at 206.

In some implementations, the mobile application 106 may be configured to generate one or more graphical user interfaces (e.g., a browser, a pop-up, etc.) that may be used by the user to provide user's login information for the selected digital service 108. The graphical user interface may be configured to be customized to appear as if it was provided by the selected digital service 108. Upon entry and submission of user's login information, the mobile application 106 may be configured to transmit the user's login information via one or more APIs 114 to the selected digital service 108 for verification/authentication.

The mobile application 106 may then be configured to transmit the provided user's login information to the selected digital service 108 for verification/authentication. The digital service may be configured to verify user's login information and transmit an appropriate indication to the mobile application 106 confirming that the provided user's login information has been verified/authenticated. Alternatively, or in addition, the mobile application 106 may be configured to use an authentication service 112 to verify/authenticate user's login information for the selected digital service 108. The authentication service 112 may be configured to execute one or more verification/authentication routines to confirm that the user's login information is authentic.

The selected digital service 108 may be configured to receive the user's login information from the APIs 114 and execute verification/authentication process. For example, the selected digital service 108 (and/or one or more of its servers) may compare the received user's login information to a stored login information for that user. As can be understood, any other methods of verifying/authenticating the user's login information may be used. Upon verifying/authenticating the user's login information, the digital service 108 may be configured to notify the mobile application 106. The mobile application 106 may then cause the authentication service 112 to encrypt and/or store the authenticated user's login information in the storage location 116, at 208. The mobile application 106 may also be configured to transmit the user's login information to the contactless card 102 for storage in the contactless card's storage location (“credentials store”), at 210. The mobile application 106 may be configured to generate a cryptogram that may include the verified user's login information and transmit it to the contactless card 102 for storage. The mobile application 106 and/or the contactless card 102 may be configured to store the authenticated user's login information for the digital service in any form (e.g., encrypted, unencrypted, etc.), location, etc.

In some implementations, the mobile application 106 and/or the contactless card 102 may store authenticated user's login information for a plurality of digital services. The multiple user's login information may be stored in a table and/or any other format and may be assigned a unique identifier so that an appropriate user's login information may be retrieved for accessing a selected digital service 108.

As can be understood, if the selected digital service 108 cannot verify/authenticate the received user's login information, the digital service may be configured to transmit an appropriate indication (e.g., an alert, an error message, etc.) to the mobile application 106. The mobile application 106 may request the user to re-enter the login information. Alternatively, or in addition, the mobile application 106 may block the user's access and prompt the user to resolve the incorrectly/improperly entered user's login information in other ways. Since the login information cannot be verified/authenticated, the mobile application 106 does not store it in the credentials store 116 nor transmits it to the contactless card 102 for storage.

Once a particular user's login information has been stored (on the contactless card 102 and/or the mobile application 106), the user may use it to access a particular digital service 108. To do so, the contactless card 102 may be brought within a predetermined area/distance of the mobile device 104 prompting it to open the mobile application 106, which, in turn, may open an application, a website, an interface, etc. for a particular digital service 108, at 212. Alternatively, or in addition, a desired digital service 108 (e.g., its application, website, interface, etc.) may be first initiated on the mobile device 104. The contactless card 102 may then be tapped on the mobile device 104 for authenticating the user for the purposes of accessing the desired digital service 108.

The stored login information may be accessed by the mobile application 106 either from the storage location 116 and/or from the contactless card 102's storage location, at 214. The accessed login information may then be used to populate login information fields for the digital service's 108 application, website, interface, etc. If the login information is being retrieved from the contactless card 102, the mobile application 106 may transmit a request to provide login information to the contactless card 102 including an identification of the specific digital service 108. The contactless card 102 may respond to the mobile application 106 by transmitting a cryptogram containing the requested login information. The cryptogram may be the cryptogram that has been previously generated by the mobile application 106 and provided to the contactless card 102 and/or a cryptogram generated by the contactless card 102 for transmission to the mobile application 106.

Upon receiving the cryptogram from the contactless card 102, the mobile application 106 may decrypt the cryptogram and extract the login information and populate the login information fields on the digital service's application, website, interface, etc. As can be understood, any desired encryption algorithms (e.g., for generating a cryptogram on the contactless card 102) and/or decryption algorithms (e.g., for decrypting the cryptogram by the mobile application 106) may be used.

In some example, non-limiting implementations, the user may also be prompted to provide user's biometric data (e.g., a fingerprint, a facial identification, etc.) to verify that the user has proper authority to access and/or use the stored login information for the selected digital service 108. The biometric data may be requested by the mobile application 106 prior to accessing the stored user's login information, and/or after retrieval but prior to populating login information fields on the digital service's application, website, interface, etc. The stored login information may be encrypted using the user's biometric data for added security, whereby use of the user's biometric data may allow the user to access the stored login information. Once the biometric data is received, the mobile application 106 (and/or an external server) may be configured to compare the received biometric data with the stored biometric data. If a match is determined, access to the stored login information may be granted; otherwise, access to the login information may be blocked.

In some implementations, the data for storage on the contactless card 102 may be encrypted (e.g., using any desired encryption protocols) using one or more external computing components, e.g., a server, a mobile device, and/or any other computing component and transmitted for storage on the contactless card 102. In the alternative, the data may be encrypted by the contactless card 102. The encrypted data stored on the contactless card 102 may be decrypted by one or more of such external computing components, once appropriate user's credentials (e.g., biometric data, passcode, login, pin, etc.) are authenticated, validated, etc. Alternatively, or in addition, the contactless card 102 may perform decryption of the stored data upon authenticating/validating user's credentials. One or more taps of the contactless card may be used to trigger encryption and/or decryption process(es). For instance, encryption and/or decryption may be accomplished using a single tap if the contactless card 102 performs the encryption and/or decryption. Multiple taps of the contactless card 102 may be used to authenticate the contactless card 102 (e.g., one tap) and to select (e.g., another tap) an encryption key (and/or decryption key) to encrypt (and/or decryption) data by external computing component(s).

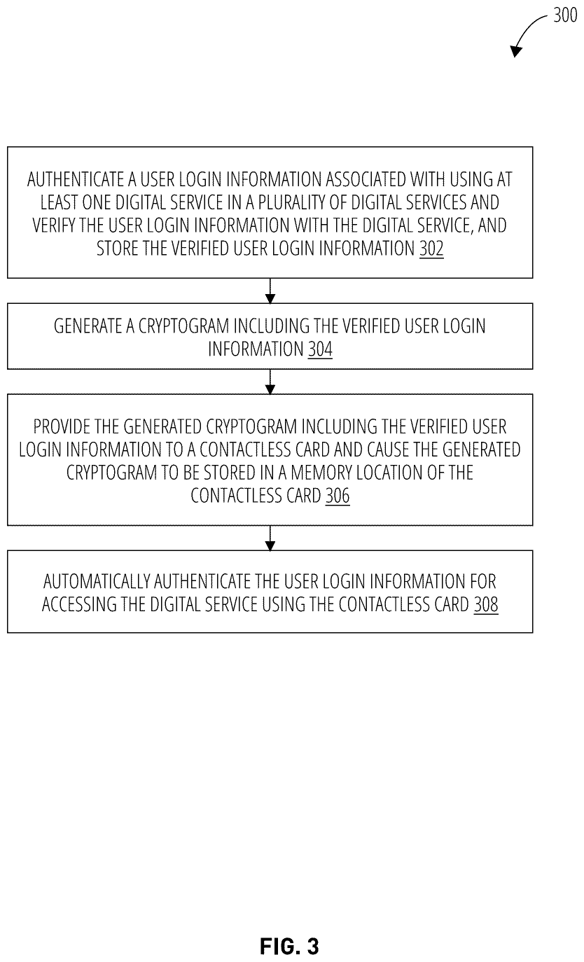

FIG. 3 illustrates an example method 300 for authenticating a user in connection with accessing one or more desired digital services, according to some implementations of the current subject matter. The method 300 may be executed by one or more components of the system 100 shown in FIGS. 1a-b. For example, the mobile application 106 along with the contactless card 102 may be configured to execute one or more operations associated with the method 300.

At 302, user's login information associated with using at least one digital service 108 (e.g., in a plurality of digital services 108 (a, b, . . . , n)) may be authenticated. As discussed above, authentication may include verifying the user's login information with the selected digital service 108 (e.g., using a multi-factor authentication, a biometric information of the user associated with the login information, and any combination thereof). In particular, verification/authentication may be accomplished by selecting at least one digital service 108 for accessing, generating a user interface associated with the selected digital service 108, receiving, via the generated user interface, the user login information (e.g., from the contactless card 102) associated with the selected digital service 108, transmitting the received user login information to the digital service 108, and executing authentication of the user login information. The verified user's login information may be stored by the mobile application 106 (e.g., in the storage location 116) and/or on the contactless card 102 (in its credentials store).

In some example implementations, the mobile application 106 may be configured to generate a cryptogram, at 304, that may be configured to include an encrypted version of the verified user's login information. The mobile application 106 may then transmit the generated cryptogram to the contactless card 102 for storage in one of its storage locations (e.g., “credentials store”), at 306. For instance, transmission of the cryptogram by the mobile application 106 to the contactless card 102 may cause the contactless card 102 to automatically store the cryptogram in a predetermined storage location. The transmitted cryptogram may be configured to include appropriate identifiers to identify the user's login information and correlate it with the corresponding digital service 108.

Once the user's login information has been verified, the contactless card 102 may be used for automatically accessing a particular digital service 108, at 308. For example, the user may select a particular shopping digital service 108 for which a login information has been stored on the contactless card 102. Selection of such service 108 may involve accessing and/or opening the service's website, application, etc. on the mobile device 104. Once the digital service's website, application, etc. has been opened, a user login interface may be generated requesting the user to provide user's login information.

The user may then bring the contactless card 102, which is storing the user's login information for the selected digital service 108, within predetermined area/distance of the mobile device 104. This may energize the circuits of the contactless card 102 and cause it to provide the stored cryptogram including the verified user login information for the selected digital service 108 and/or generate a new cryptogram that contains the user's login information for transmission to the mobile application 106 and/or any other application. The contactless card 102 may encrypt the verified user login information in any desired way.

In some implementations, the cryptogram (e.g., either generated by the mobile application 106 and/or the contactless card 102) may be configured to include a plurality of user login information, where each user login information may be associated with a respective digital service 108 in the plurality of services 108 (a, b, . . . , n). This may be helpful when accessing more than one digital services on the mobile device 104.

In some example implementations, the user's login information may be updated and/or changed. For instance, the user may wish and/or may be required to update user's login information (e.g., change password). As such, the mobile application 106 may be configured to generate an updated cryptogram. The cryptogram may be generated subsequent to verification of the updated/changed user's login information and may include a verified updated user login information associated with one or more digital services 108 for which update/change was requested and/or performed. Moreover, the updated cryptogram may include another verified user login information associated with another digital service 108. This may be useful when access to further digital services 108 (e.g., those that were not selected when the original cryptogram was generated) may be desired. Once the updated cryptogram has been generated, it may be provided to the contactless card 102 for storage. Upon receipt of the updated cryptogram, the contactless card 102 may be configured to store the updated cryptogram to its storage location. The previously stored cryptogram may be discarded and/or archived.

In some implementations, the current subject matter may be configured to automatically access the selected digital service 108 from the mobile device 104 upon receipt of the stored user's login information from the contactless card 102. Such automatic access may include generation of a digital service user interface associated with the selected digital service 108. Since the user's login information has been already verified, its authentication may be bypassed. Once the user's login information is provided, the digital service user interface may then be configured to enable access to one or more secure digital services associated with the selected digital service 108.

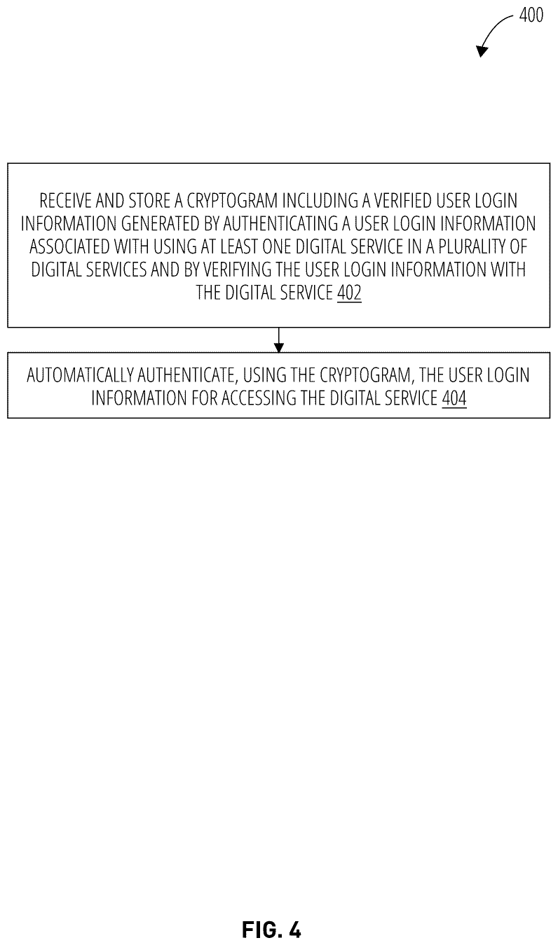

FIG. 4 illustrates an example method 400 for authenticating a user in connection with accessing one or more desired digital services, according to some implementations of the current subject matter. The method 400 may be executed by one or more components of the system 100 shown in FIGS. 1a-b. For example, the mobile application 106 along with the contactless card 102 may be configured to execute one or more operations associated with the method 400.

At 402, the mobile application 106 and/or the contactless card 102 may be configured to receive and store a cryptogram that may include a verified user login information. The verified user login information may be generated by authenticating a user login information associated with using at least one digital service 108 (as shown in FIGS. 1a-b) and by verifying the user login information with the digital service 108. This may involve transmission of user login information that has been provided to the digital service 108 (e.g., one of its servers) for verification.

In some implementations, the generated cryptogram may be configured to include a plurality of user's login information (e.g., different username/password combinations) for multiple digital services 108. Each user login information included in the cryptogram may be identified by a specific unique identifier that may be used to select and/or retrieve the login information for the selected service.

As stated above, cryptogram may be updated using updated user's login information for one or more digital services. The updated user's login information may include a changed information for a specific existing digital service and/or new user's login information for new digital service. Each updated/new user's login information may be verified/authenticated (e.g., using a multi-factor authentication, a biometric information of the user associated with the login information, etc. and/or any combination thereof) as discussed herein.

At 404, the cryptogram may be used to automatically authenticate the user login information for accessing the selected digital service 108. This way, the user is not required to enter the user's login information every time the user wishes to use secure areas of the digital service 108, and instead, the contactless card 102 (and/or the user's login information stored by the mobile application 106) may be used for authentication. User's access to the digital service 108 and user's subsequent authentication, using the cryptogram, may involve the mobile application 106 receiving a selection of the specific digital service 108 for accessing, which triggers generation of a user interface associated with the selected digital service 108. The contactless card 102 and/or storage location 116 may be used to identify the stored verified (existing and/or updated) user login information associated with the selected digital service 108. Once identified, the user login information may be transmitted from the contactless card 102 to the mobile application 106 and via the API(s) 114 to the digital service 108, thereby causing automatic access to the digital service 108 using the stored verified user login information. This process may be configured to bypass separate entry by the user of and subsequent authentication of the user's login information for the selected digital service 108.

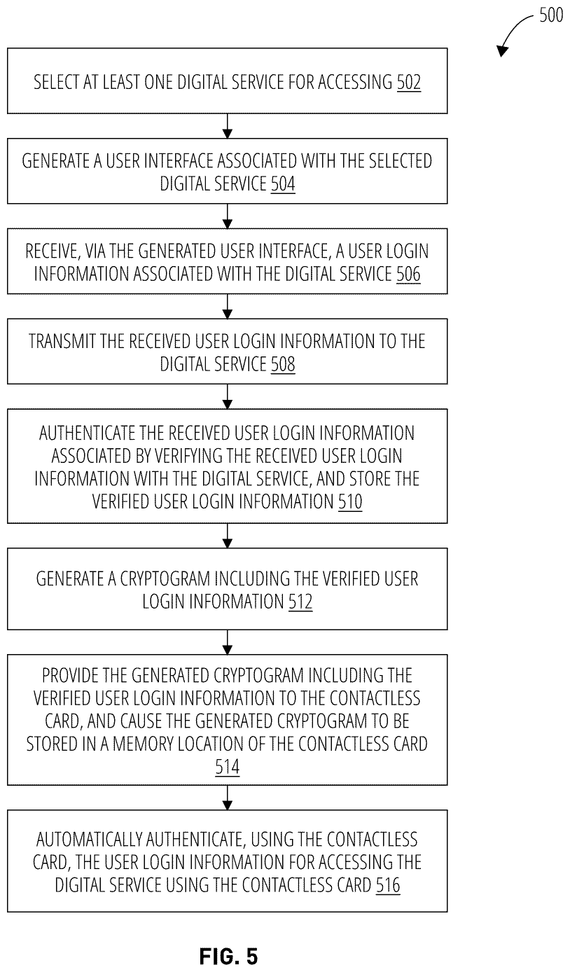

FIG. 5 illustrates another example method 500 for authenticating a user in connection with accessing one or more desired digital services, according to some implementations of the current subject matter. Similar to methods 300 and 400, the method 500 may also be executed using the system 100, e.g., by the mobile application 106 and/or the contactless card 102.

At 502, at least one digital service 108 may be selected for accessing (e.g., using mobile device 104 and/or mobile application 106). A user interface associated with the selected digital service 108 may be generated, at 504.

The generated user interface may be used for receiving a user login information associated with the selected digital service 108, at 506. For example, the user interface may have one or more fillable fields for entry of the username and/or password as user's login information.

At 508, the received user login information may be transmitted to the selected digital service 108 for verification/authentication. The digital service 108 (and/or any of its associated servers) may be configured to authenticate the received user login information associated by verifying it against records stored by the digital service 108. Once confirmed, the digital service 108 may be configured to transmit an appropriate indication to the mobile application 106, which may store the verified user login information, at 510. At 512, a cryptogram including the verified user login information may be generated by, for example, the mobile application 106.

At 514, the generated cryptogram including the verified user login information may be provided to the contactless card 102, which may cause the generated cryptogram to be stored in a memory location of the contactless card 102.

At 516, the contactless card 102 may be used to automatically authenticate the user login information for accessing the selected digital service 108.

FIG. 6 illustrates a data transmission system 600 according to an example embodiment. As further discussed below, system 600 may include contactless card 602, client device 604, network 606, and server 608. Although FIG. 6 illustrates single instances of the components, system 600 may include any number of components.

System 600 may include one or more contactless cards 602, which are further explained below. In some embodiments, contactless card 602 may be in wireless communication, utilizing NFC in an example, with client device 604.

System 600 may include client device 604, which may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. Client device 604 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The client device 604 device can include a processor and a memory, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. The client device 604 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touchscreen, keyboard, mouse, cursor-control device, touchscreen, microphone, digital camera, video recorder or camcorder. These devices may be used to enter information and interact with the software and other devices described herein.

In some examples, client device 604 of system 600 may execute one or more applications, such as software applications, that enable, for example, network communications with one or more components of system 600 and transmit and/or receive data.

The client device 604 may be in communication with one or more server(s) 608 via one or more network(s) 606, and may operate as a respective front-end to back-end pair with server 608. The client device 604 may transmit, for example from a mobile device application executing on client device 604, one or more requests to server 608. The one or more requests may be associated with retrieving data from server 608. The server 608 may receive the one or more requests from client device 604. Based on the one or more requests from client device 604, server 608 may be configured to retrieve the requested data from one or more databases (not shown). Based on receipt of the requested data from the one or more databases, server 608 may be configured to transmit the received data to client device 604, the received data being responsive to one or more requests.

System 600 may include one or more networks 606. In some examples, network 606 may be one or more of a wireless network, a wired network or any combination of wireless network and wired network, and may be configured to connect client device 604 to server 608. For example, network 606 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 606 may include, without limitation, telephone lines, fiber optics, IEEE Ethernet 802.3, a wide area network, a wireless personal area network, a LAN, or a global network such as the Internet. In addition, network 606 may support an Internet network, a wireless communication network, a cellular network, or the like, or any combination thereof. network 606 may further include one network, or any number of the exemplary types of networks mentioned above, operating as a stand-alone network or in cooperation with each other. network 606 may utilize one or more protocols of one or more network elements to which they are communicatively coupled. network 606 may translate to or from other protocols to one or more protocols of network devices. Although network 606 is depicted as a single network, it should be appreciated that according to one or more examples, network 606 may comprise a plurality of interconnected networks, such as, for example, the Internet, a service provider's network, a cable television network, corporate networks, such as credit card association networks, and home networks.

System 600 may include one or more servers 608. In some examples, server 608 may include one or more processors, which are coupled to memory. The server 608 may be configured as a central system, server or platform to control and call various data at different times to execute a plurality of workflow actions. Server 608 may be configured to connect to the one or more databases. The server 608 may be connected to at least one client device 604.

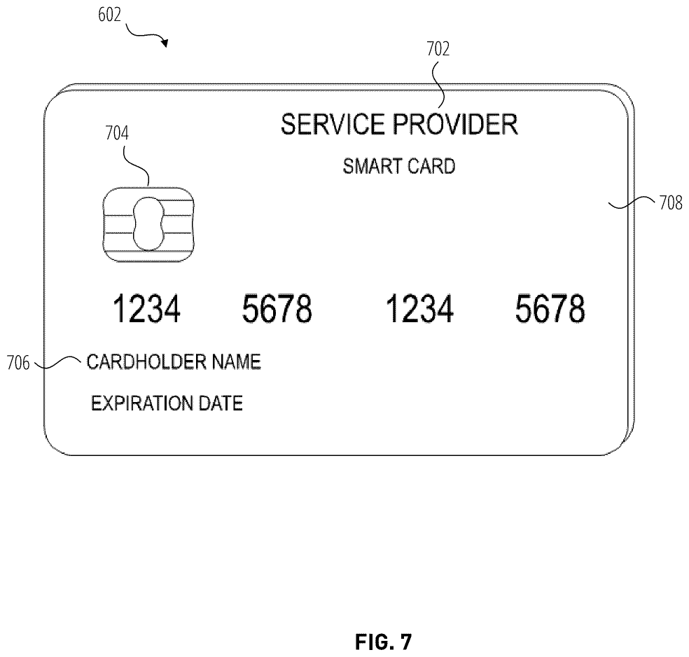

FIG. 7 illustrates an example configuration of a contactless card 602, which may include a contactless card, a payment card, such as a credit card, debit card, or gift card, issued by a service provider as displayed as service provider indicia 702 on the front or back of the contactless card 602. In some examples, the contactless card 602 is not related to a payment card, and may include, without limitation, an identification card. In some examples, the transaction card may include a dual interface contactless payment card, a rewards card, and so forth. The contactless card 602 may include a substrate 708, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 602 may have physical characteristics compliant with the ID-1 format of the ISO/IEC 7816 standard, and the transaction card may otherwise be compliant with the ISO/IEC 14443 standard. However, it is understood that the contactless card 602 according to the present disclosure may have different characteristics, and the present disclosure does not require a transaction card to be implemented in a payment card.

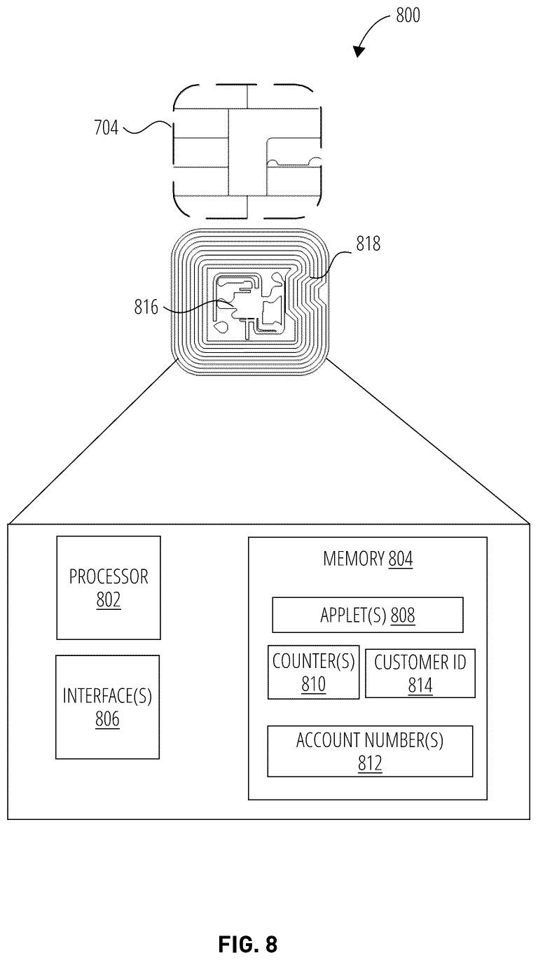

The contactless card 602 may also include identification information 706 displayed on the front and/or back of the card, and a contact pad 704. The contact pad 704 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 602 may also include processing circuitry, antenna and other components as will be further discussed in FIG. 8. These components may be located behind the contact pad 704 or elsewhere on the substrate 708, e.g., within a different layer of the substrate 708, and may electrically and physically coupled with the contact pad 704. The contactless card 602 may also include a magnetic strip or tape, which may be located on the back of the card (not shown in FIG. 7). The contactless card 602 may also include a Near-Field Communication (NFC) device coupled with an antenna capable of communicating via the NFC protocol. Embodiments are not limited in this manner.

As illustrated in FIG. 7, the contact pad 704 of contactless card 602 may include processing circuitry 816 for storing, processing, and communicating information, including a processor 802, a memory 804, and one or more interface(s) 806. It is understood that the processing circuitry 816 may contain additional components, including processors, memories, error and parity/CRC checkers, data encoders, anticollision algorithms, controllers, command decoders, security primitives and tamperproofing hardware, as necessary to perform the functions described herein.

The memory 804 may be a read-only memory, write-once read-multiple memory or read/write memory, e.g., RAM, ROM, and EEPROM, and the contactless card 602 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 804 may be encrypted memory utilizing an encryption algorithm executed by the processor 802 to encrypted data.

The memory 804 may be configured to store one or more applet(s) 808, one or more counter(s) 810, a customer identifier 814, and the account number(s) 812, which may be virtual account numbers. The one or more applet(s) 808 may comprise one or more software applications configured to execute on one or more contactless cards, such as a Java® Card applet. However, it is understood that applet(s) 808 are not limited to Java Card applets, and instead may be any software application operable on contactless cards or other devices having limited memory. The one or more counter(s) 810 may comprise a numeric counter sufficient to store an integer. The customer identifier 814 may comprise a unique alphanumeric identifier assigned to a user of the contactless card 602, and the identifier may distinguish the user of the contactless card from other contactless card users. In some examples, the customer identifier 814 may identify both a customer and an account assigned to that customer and may further identify the contactless card 602 associated with the customer's account. As stated, the account number(s) 812 may include thousands of one-time use virtual account numbers associated with the contactless card 602. An applet(s) 808 of the contactless card 602 may be configured to manage the account number(s) 812 (e.g., to select an account number(s) 812, mark the selected account number(s) 812 as used, and transmit the account number(s) 812 to a mobile device or a client device 604 for autofilling by an autofilling service.

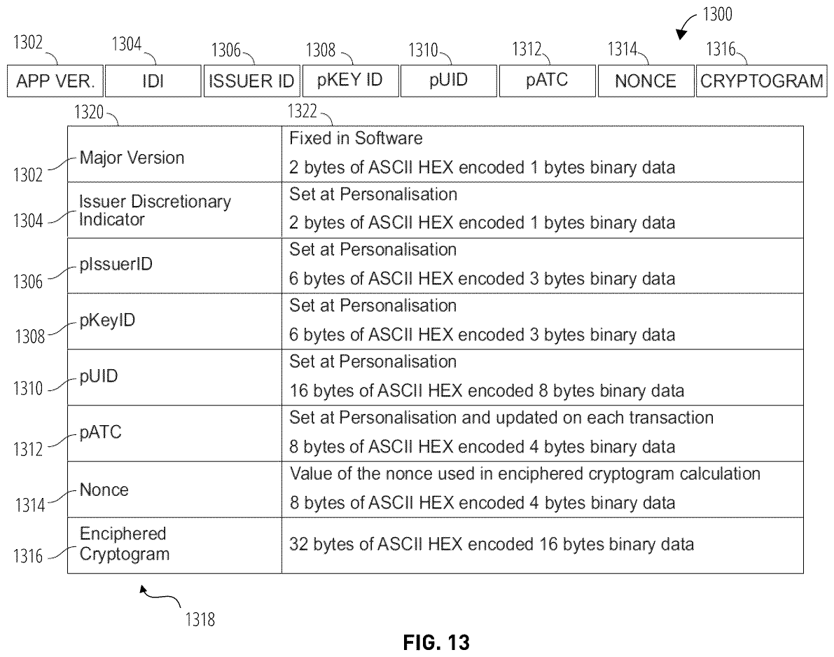

In some embodiments, the memory 804 can include (e.g., have stored therein) the data from the fields shown in FIG. 8 and/or FIG. 13. The processor 802 can then use the data from the fields to generate the message 1300 as described above.

The processor 802 and memory elements of the foregoing exemplary embodiments are described with reference to the contact pad 704, but the present disclosure is not limited thereto. It is understood that these elements may be implemented outside of the contact pad 704 or entirely separate from it, or as further elements in addition to processor 802 and memory 804 elements located within the contact pad 704.

In some examples, the contactless card 602 may comprise one or more antenna(s) 818. The one or more antenna(s) 818 may be placed within the contactless card 602 and around the processing circuitry 816 of the contact pad 704. For example, the one or more antenna(s) 818 may be integral with the processing circuitry 816 and the one or more antenna(s) 818 may be used with an external booster coil. As another example, the one or more antenna(s) 818 may be external to the contact pad 704 and the processing circuitry 816.

In an embodiment, the coil of contactless card 602 may act as the secondary of an air core transformer. The terminal may communicate with the contactless card 602 by cutting power or amplitude modulation. The contactless card 602 may infer the data transmitted from the terminal using the gaps in the contactless card's power connection, which may be functionally maintained through one or more capacitors. The contactless card 602 may communicate back by switching a load on the contactless card's coil or load modulation. Load modulation may be detected in the terminal's coil through interference. More generally, using the antenna(s) 818, processor 802, and/or the memory 804, the contactless card 602 provides a communications interface to communicate via NFC, Bluetooth, and/or Wi-Fi communications.

As explained above, contactless card 602 may be built on a software platform operable on smart cards or other devices having limited memory, such as JavaCard, and one or more or more applications or applets may be securely executed. Applet(s) 808 may be added to contactless cards to provide a one-time password (OTP) for multifactor authentication (MFA) in various mobile application-based use cases. Applet(s) 808 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 808 may be configured to encode the OTP as an NDEF type 4 well known type text tag. In some examples, NDEF messages may comprise one or more records. The applet(s) 808 may be configured to add one or more static tag records in addition to the OTP record.

In some examples, the one or more applet(s) 808 may be configured to emulate an RFID tag. The RFID tag may include one or more polymorphic tags. In some examples, each time the tag is read, different cryptographic data is presented that may indicate the authenticity of the contactless card. Based on the one or more applet(s) 808, an NFC read of the tag may be processed, the data may be transmitted to a server, such as a server of a banking system, and the data may be validated at the server.

In some examples, the contactless card 602 and server may include certain data such that the card may be properly identified. The contactless card 602 may include one or more unique identifiers (not pictured). Each time a read operation takes place, the counter(s) 810 may be configured to increment. In some examples, each time data from the contactless card 602 is read (e.g., by a mobile device), the counter(s) 810 is transmitted to the server for validation and determines whether the counter(s) 810 are equal (as part of the validation) to a counter of the server.

The one or more counter(s) 810 may be configured to prevent a replay attack. For example, if a cryptogram has been obtained and replayed, that cryptogram is immediately rejected if the counter(s) 810 has been read or used or otherwise passed over. If the counter(s) 810 has not been used, it may be replayed. In some examples, the counter that is incremented on the card is different from the counter that is incremented for transactions. The contactless card 602 is unable to determine the application transaction counter(s) 810 since there is no communication between applet(s) 808 on the contactless card 602.

In some examples, the counter(s) 810 may get out of sync. In some examples, to account for accidental reads that initiate transactions, such as reading at an angle, the counter(s) 810 may increment but the application does not process the counter(s) 810. In some examples, when the client device 604 is woken up, NFC may be enabled and the client device 604 may be configured to read available tags, but no action is taken responsive to the reads.

To keep the counter(s) 810 in sync, an application, such as a background application, may be executed that would be configured to detect when the mobile client device 604 wakes up and synchronize with the server of a banking system indicating that a read that occurred due to detection to then move the counter(s) 810 forward. In other examples, Hashed One Time Password may be utilized such that a window of mis-synchronization may be accepted. For example, if within a threshold of 10, the counter(s) 810 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 810 increases in the appropriate sequence, then it possible to know that the user has done so.

The key diversification technique described herein with reference to the counter(s) 810, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 602, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 602. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 602 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

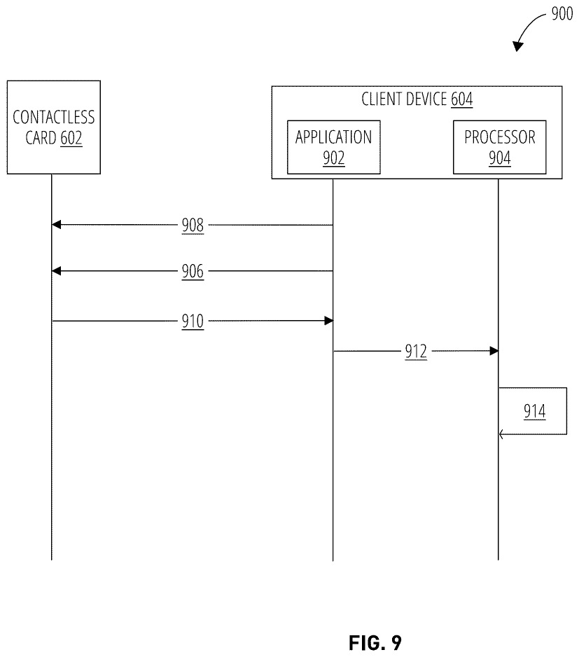

FIG. 9 is a timing diagram illustrating an example sequence for providing authenticated access according to one or more embodiments of the present disclosure. Sequence flow 900 may include contactless card 602 and client device 604, which may include an application 902 and processor 904.

At line 908, the application 902 communicates with the contactless card 602 (e.g., after being brought near the contactless card 602). Communication between the application 902 and the contactless card 602 may involve the contactless card 602 being sufficiently close to a card reader (not shown) of the client device 604 to enable NFC data transfer between the application 902 and the contactless card 602.

At line 906, after communication has been established between client device 604 and contactless card 602, contactless card 602 generates a message authentication code (MAC) cryptogram. In some examples, this may occur when the contactless card 602 is read by the application 902. In particular, this may occur upon a read, such as an NFC read, of a near field data exchange (NDEF) tag, which may be created in accordance with the NFC Data Exchange Format. For example, a reader application, such as application 902, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 602 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 902 may be configured to transmit a request to contactless card 602, the request comprising an instruction to generate a MAC cryptogram.

At line 910, the contactless card 602 sends the MAC cryptogram to the application 902. In some examples, the transmission of the MAC cryptogram occurs via NFC, however, the present disclosure is not limited thereto. In other examples, this communication may occur via Bluetooth, Wi-Fi, or other means of wireless data communication. At line 912, the application 902 communicates the MAC cryptogram to the processor 904.

At line 914, the processor 904 verifies the MAC cryptogram pursuant to an instruction from the application 902. For example, the MAC cryptogram may be verified, as explained below. In some examples, verifying the MAC cryptogram may be performed by a device other than client device 604, such as a server of a banking system in data communication with the client device 604. For example, processor 904 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

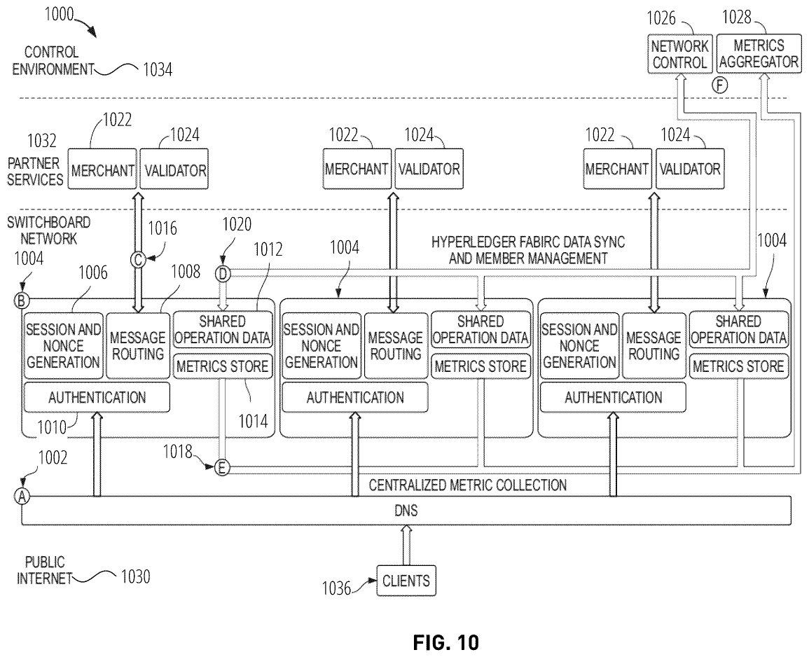

FIG. 10 illustrates an example of system 1000 in accordance with the embodiments discussed herein. The system 1000 includes additional devices and systems configured to enable contactless card issuers to tap-to-card services. Specifically, system 1000 enables any number of issuer systems to provide card services to their clients through a switching fabric, i.e., the switchboard system in a secure and safe manner.

In embodiments, the switchboard system includes one or more nodes 1004 configured to perform routing operations. Each switchboard node 1004 may include a session and nonce generator 1006, a message router 1008, an authentication 1010, an operation data 1012 store, and a metrics store 1014. Further, each of the nodes may be configured the same and share configurations, but each switchboard node 1004 may independently process and route messages and requests to the appropriate systems, such as the merchant systems and issuer systems. Each of the nodes 1004 is configured to act as a broker of trust between an issuer system, the merchant system 1022, and/or validation system 1024, for example. Each switchboard node 1004 is configured to route each message to the correct issuer system while maintaining data security. For example, a switchboard node 1004 may route a message between an issuer system and a merchant system while the node cannot access the private data in the message.

The switchboard system 1000 may be configured as a server system with a collection of hardware, software, and networking components that work together to provide client services. Hardware components may include one or more server computers, storage devices, and net work adapters. The server computers are configured to run server applications, such as those executable on each of the nodes 1004. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

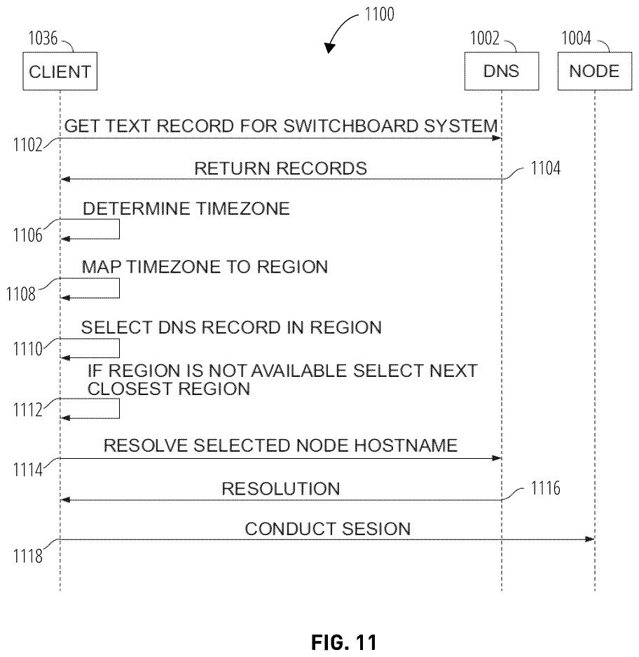

In some embodiments, the nodes 1004 may operate in a cloud-based computing environment, e.g., a collection of hardware, software, and networking components that enable the delivery of cloud computing services. The switchboard nodes 1004 and the computing services are delivered over the Internet and can be accessed from anywhere in the world with an Internet connection. In embodiments, client 1036 may access a switchboard node 1004 through DNS 1002 or Domain Name System (DNS). The DNS 1002 is a hierarchical and distributed naming system for computers, services, and other resources connected to the Internet or other networks. It associates various information with domain names assigned to each registered participant. In one example, the DNS 1002 may translate a name known to software executing on a client 1036 to route data to one or more of switchboard node 1004 of the switchboard system. In embodiments, the DNS 1002 may generate a number, such as an Internet Protocol (IP) address, an address record (A-record), or another Hostname (C-name record). FIG. 11 illustrates one example sequence 1100 for a client to identify and resolve an identifier for one of the nodes 1004 of the switchboard system. At a high level, the DNS 1002 translates known domain names to numerical Internet Protocol (IP) addresses needed for locating and identifying computer services and devices with the underlying network protocols. Clients use the global DNS system to select the best node to use, as discussed in sequence 1100.

In embodiments, a client 1036 communicates with the switchboard system to perform one or more of the partner services 1032, such as conducting a transaction with a merchant, validating the customer, or other tap-to functions. Once client 1036 identifies a switchboard node 1004 and resolves an address to communicate with switchboard node 1004, client 1036 may send one or more messages to switchboard node 1004 to authenticate and perform the operation. The switchboard node 1004 includes an authentication 1010 function that is configured to authenticate the client 1036. In embodiments, the client 1036 sends a message or authorization request to the switchboard node 1004 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where Table 1 describes the value, name, and meaning:

TABLE 1

| Value | Name | Meaning |
|---|---|---|
| 65535 | Client ID | Individual identifier of client |
| GReyx5BuEAaE72bWbFZJfHRL8Dbt1Uum | Client Key | Randomly assigned key |

The switchboard node 1004 may authorize or authenticate the client 1036 or user, and the switchboard node 1004 may utilize the additional components, such as the session and nonce session and node generator 1006 and message router 1008, to perform the operations. Note the validation systems validation system 1024 never interact with the merchant systems 1022, nor vice versa. The nodes node 1004 brokers all communication.

In embodiments, the switchboard system may utilize a hyper ledger fabric 1020 to manage to synchronize the shared operation data 1012 and member management across the network. The hyperledger fabric 1020 is distributed ledger framework having a permissioned network model that only authorized participants can join the network and access the data that is stored on a ledger.

In embodiments, the hyperledger fabric 1020 may be generated by creating one or more sets of peers, an ordering service, and a channel. Once the network is created, system 1000 deploys chaincode to the network, or node 1004 is permitted to access the fabric. The chaincode is the code that runs on the blockchain and executes the network control 1026 and operation data 1012 logic code. Once the chaincode is deployed, each of the switchboard nodes 1004 is configured to invoke transactions on the blockchain to add data to the blockchain, e.g., the operational data. A switchboard node 1004 or another device can query the ledger to retrieve data. The ledger is a distributed database that stores all the data added to the blockchain.

All nodes 1004 keep an independently verifiable log of their actions that can be transmitted to a centralized aggregator to build a picture of overall network usage. System 1000 can manage network operation data and management at a central level and have a centralized view of network use, aggregated and abstracted to the appropriate level.

FIG. 11 illustrates an example sequence 1100 for a client to utilize DNS to resolve and communicate with one or more nodes of a switchboard system. The illustrated sequence 1100 includes a client 1036, a DNS 1002, and a switchboard node 1004. At 1102, the sequence 1102 includes the client 1036 sending a request to a default DNS server for a text record switchboard. {domain}. {tld}. The text record may be preconfigured in a client app and/or client SDK. At 1104, the DNS 1002 returns one or more records. A DNS record structure may include the following:
Root Record:
   Name: switchboard. {domain}. {tld}
   Type: TXT
   Resolution:

▪ {nodename_1}.{operator_a}.{region_i}.switchboard.{domain}.{tld},
▪ {nodename_2}.{operator_a}.{region_i}.switchboard.{domain}.{tld},
▪ {nodename_1}.{operator_b}.{region_ii}.switchboard.{domain}.{tld},
▪ {nodename_2}.{operator_b}.{region_ii}.switchboard.{domain}.{tld},
▪ * etc.

Used For determining where there are active nodes
Node Record:

∘ Name: {nodename}.{operator}.{region}.switchboard.{domain}.{tld}
∘ Type: A/AAAA or CNAME
∘ Resolution: Actual node hostname or IP
∘ Used For: communicating with a node 1004

In embodiments, the client 1036 may determine the current timezone at 1106. For example, the client app or SDK may utilize a get current timezone function, such as in JavaScript: Intl.DateTimeFormat( ).resolvedOptions( ).timeZone). Embodiments are not limited in this manner, and the app or sdk may determine the timezone via another/different function call. At 1108, the client 1036 is configured to map the timezone to a region or short-version identifier of the region. One example includes America/New_York->na-e. The region may be based on DNS names, for example. Table 2 illustrates a few examples of timezone mappings to regions:

TABLE 2

| Timezone | Region | Short Version |
|---|---|---|
| America/New_York | North America / East | na-e |
| America/Buenos_Aires | South America | sa |
| US/Pacific | North America / West | na-w |
| Europe/Paris | Europe | eu |

Embodiments are not limited to these examples, and other timezone-to-region mappings may be utilized. Further and in embodiments, Regions can also be represented as a bidirectional graph structure with the edges representing geographic neighbors. For example, na-e <-> na-w and sa <-> na-w and sa <-> na-e. This representation is useful for node selection.

At 1110, the client 1036 may identify or select a DNS record option returned at 1104 that is in the region. If there are multiple matches, the client 1036 may select one at random. If there is no node available in a region, the client 1036 may determine and use a data graph of neighboring regions to select a node in the closest region where a node is available at 1112. For example, sa has no node but is connected to na-e where there is a node and so na-e is selected. In some embodiments,

At 1114, the client may resolve a selected node's hostname. In embodiments, the client 1036 may automatically resolve the hostname using the client's HTTP request default resolver. At 1116, the DNS 1002 may return a result. And at 1118, the client 1036 may communicate with a switchboard node 1004 and begin the process to interact with the switchboard.

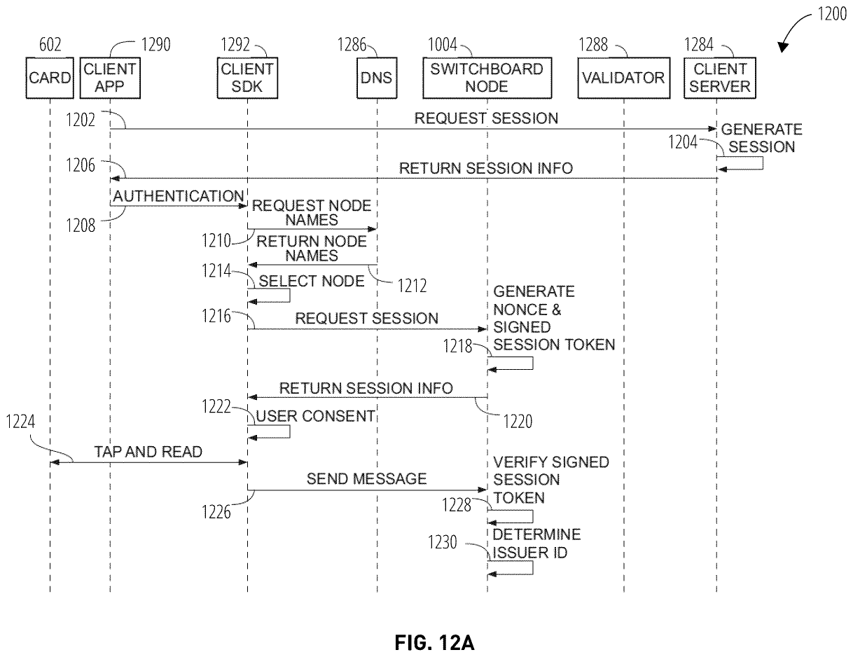

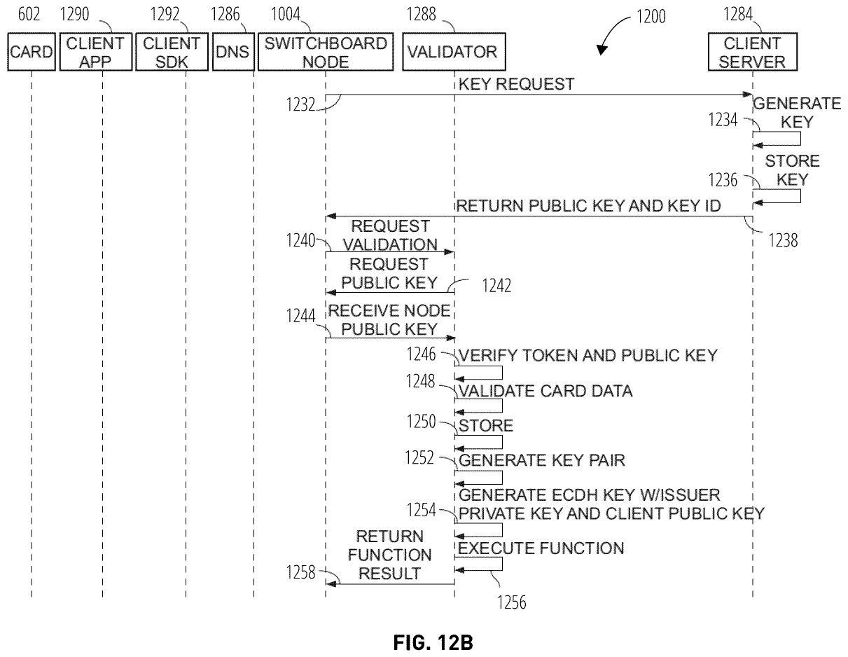

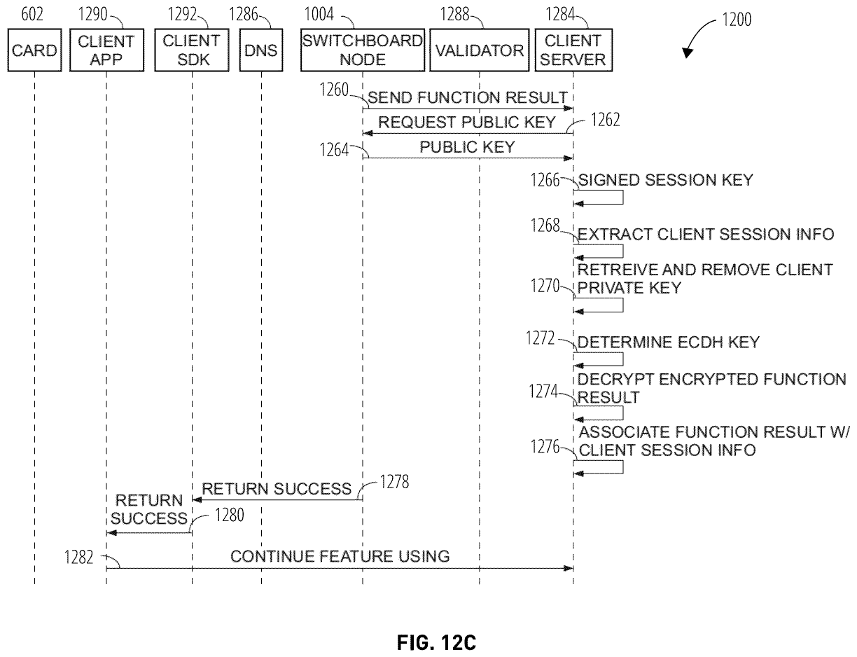

FIG. 12A-FIG. 12C illustrate an example sequence 1200 to perform operations between a contactless card 602 and services provided by a card issuer and/or merchant. The illustrated sequence 1200 includes actions and communications performed by a contactless card 602, a client 1036 including a client app 1290 and a client SDK 1292, a DNS 1286, a switchboard system including one or more nodes 1004, a partner services 1032 including a merchant and/or validator 1288, and control services 1034 including a client server 1284 or system. In embodiments, the client app 1290 may be any application configured to execute on a client 1036, such as a banking app, a merchant app, a social media app, a travel app, a gaming app, a productivity app, an entertainment app, and so forth. In embodiments, the client app 1290 includes a web browser to provide websites and pages. The client app 1290 may include and/or utilize the client SDK 1292, which may be a set of instructions that enable the client app 1290 to communicate with other components of the switchboard system.

In embodiments, as shown in FIG. 12A, at 1202 the client 1036 including the client app may send a request and establish a session with a client server 1284 such that a result may be associated with the correct client device or user. The request establishes a relationship between the client device and client server, which may be an issuer server. At 1204, the client server 1284 generates a session and CLIENT SESSION INFORMATION. At 1206, the client server 1284 returns the session information, e.g., the CLIENT SESSION INFORMATION. In embodiments, the CLIENT SESSION INFORMATION may be the Client implementation-specific user session identification information.

At 1208, the client 1036 may initiate a contactless card authentication process with the client 1036. For example, the client 1036 may call a function and/or pass information to the client 1036 to initiate authentication via a contactless card 602. At 1210-1214, the client 1036 may utilize DNS to identify a node and establish communication with the node. Specifically, at 1210, the client 1036 including the client SDK 1292 may send a request for switchboard hostnames, and at 1212 the DNS 1286 may return information including one or more hostnames. At 1214, the client 1036 may determine a switchboard node to communicate. FIG. 11 illustrates an example of a more detailed sequence of the process to establish communication with a switchboard node 1004.

At 1216, the client 1036 may send a request for a session to the switchboard system 1000. In embodiments, the request for a session may be for a function request in the format <FUNCTION REQUEST>. In embodiments, the FUNCTION REQUEST may be the data/function that the client 1036 would like to request once a contactless card 602 has been validated. The function could be for any service discussed herein, e.g., authenticate the user, perform a transaction, request autofill data, etc. At 1218, switchboard system 1000 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card 602. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>, <CLIENT SESSION INFO>, and <FUNCTION REQUEST> signed with <NODE PRIVATE KEY>, where the NODE PRIVATE KEY is the switchboard system 1000 private key. The switchboard system 1000 may include a NODE PUBLIC/PRIVATE KEY, which is a keypair used to sign and validate JWTs.

At 1220, the switchboard system 1000 may return session information to the client 1036. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 1222, the client SDK 1292 may determine and/or receive user consent to the terms of service. In one example, the client SDK 1292 captures and records the user consent to <FUNCTION TOS> on <CONSENT DATE> with <TOS VERSION>. The CONSENT DATE may be the timestamp for the user's consent to the TOS.

At 1224, the client 1036 exchanges one or more messages with a contactless card. In one example, the exchange may be based on the contactless card being tapped to a client device. In embodiments, the client SDK 1292 may provide data to the contactless card 602 to use during the session to perform the function. The data may be provided to the contactless card 602 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an example of an NDEF message format.

TABLE 3

| Byte | Data Item | Value |
|---|---|---|
| 00 | NDEF Message Tag | D1 (only record) |
| 01 | Length of Record | 01 |
| | Type | |
| 02 | Length of Record | 33 |
| 03 | text record type | 54 |
| 04 | Length of Language | 02 |
| 05-06 | Language | 65 6E (“en”) |
| 07 . . . 0E | NONCE | 8 bytes of ASCII HEX encoded 4 bytes binary data |
| 0F . . . 12 | Session Indicators | 4 bytes of ASCII HEX encoded 2 bytes binary data |
| 13 . . . 16 | Control Indicators | 4 bytes of ASCII HEX encoded 2 bytes binary data |
| 17 . . . 26 | Update Date | 16 bytes of ASCII HEX encoded 8 bytes binary data - |
| | creation Time | represents 64 bit unix timestamp |
| 27 . . . 36 | Update MAC | MAC to protect control indicators - 16 bytes of ASCII |
| | | HEX encoded 8 bytes binary data |

The updated MAC may be calculated to protect the control indicators in embodiments. Specifically, The MAC M is determined by calculating a MAC over the 10 bytes of the update data U with the Update MAC Card Key (MCK), as described in FIG. 13, message 1300.

At 1224, the contactless card may generate and provide a message to the client's device including the client SDK 1292. The data in the message may be utilized by the system discussed herein to perform the function requested. One example of the message is illustrated and discussed in FIG. 13, message 1300.

At 1226, the client including the client SDK 1292 may send a message and information to the switchboard system 1000. The message may be the message received from the contactless card 602, e.g., message 1300. In addition, the client SDK 1292 may send the consent date, the TOS version, and the signed session token to the switchboard system 1000. The switchboard system 1000 may utilize the information to ensure the session is valid. At 1228, the switchboard system 1000 verifies the signed session token is valid, e.g., is the previously provided signed session token and includes the nonce previously generated and is in the message.

In some embodiments, the switchboard system 1000 is configured to determine which issuer system or client-server it should route the message to for processing. At 1230, the switchboard system 1000 may determine the issuer ID by extracting it from the message received from the contactless card 602 via the client SDK 1292. As mentioned, the issuer ID identifies the issuer of the contactless card 602.

FIG. 12B continues the sequence 1200 from FIG. 12A. In embodiments, the switchboard system 1000 is configured to generate and communicate secure communications with the issuer system, e.g., the client server 1284 and the validator 1288. At 1232, the switchboard system 1000 sends a request for a key to the client server 1284. The key may be utilized to perform secure communications. In one example, the key request may be an elliptical curve Diffie-Hellman (ECDH) key request. Embodiments are not limited in this manner. Alternative key protocols may be utilized, e.g., Supersingular isogeny Diffie-Hellman key exchange (SIDH or SIKE), a private/public key pairing (RSA), etc.

At 1234, the client server 1284 generates a portion of the key. In some instances, the client server 1284 may generate half of the ECDH key for encryption/decryption of PII. Specifically, the client server 1284 may generate <CLIENT EC PUBLIC KEY> and <CLIENT EC PRIVATE KEY> using Elliptic Curve P256. The CLIENT EC PUBLIC KEY AND CLIENT EC PRIVATE KEY is the first half of the ECDH key negotiation.

At 1236, the client-server 1284 stores the generated portion of the key in storage. Specifically, the client server 1284 may store <CLIENT EC PUBLIC KEY> and <CLIENT EC PRIVATE KEY> with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 1284 may return the public key portion to the switchboard system 1000 with the KEY ID at 1238. The switchboard system 1000 may store the public key portion with the KEY ID for later use, e.g., generation of the ECDH key. At 1240, the switchboard system 1000 may request a validation to be performed by the validator 1288. In one example, the switchboard system 1000 may send a request validation as Request validation <MESSAGE>, <SIGNED SESSION TOKEN>, <CLIENT EC PUBLIC KEY>, <CONSENT DATE>, and the <TOS VERSION>. The validator 1288 may make an out-of-band request back to the switchboard system 1000 for the public key to verify the session at 1242. At 1244, the switchboard system 1000 may provide the node's public key, i.e., <NODE PUBLIC KEY>. Further at 1246, the validator 1288 may utilize the node's public key to verify the secure session token.

In embodiments, the validator 1288 may validate the message at 1248. In embodiments, the validator 1288 may perform a number of validations including ensuring the nonce in the message is correct along with additional information, such as the card's unique identifier (pUID), and the counter value (pATC).

At 1250, the validator 1288 may store information associated with the session. For example, validator 1288 may store the <CONSENT DATE> with the <TOS VERSION> and the <PUID>. The validator 1288 may also generate another portion of the key, e.g., the ECDH key. For example, the 1288 may Generate <ISSUER EC PUBLIC KEY> and <ISSUER EC PRIVATE KEY> using Elliptic Curve P256. The ISSUER EC PUBLIC KEY and ISSUER EC PRIVATE KEY may be the second half of the ECDH key negotiation.

At 1254, the validator 1288 may generate the complete ECDH key. For example, the validator 1288 generates the <ECDH KEY> from <ISSUER EC PRIVATE KEY> and <CLIENT EC PUBLIC KEY>. The ECDH KEY is the final key generated using ECDH key negotiation.

The validator 1288 may utilize the ECDH KEY to encrypt data for the function. For example, if the validator 1288 validates the message in some instances, the validator 1288 may execute a function request to create a function result and encrypt the result with the ECDH KEY at 1256. For example, the validator 1288 may Execute <FUNCTION REQUEST> to create <FUNCTION RESULT> and encrypt it with the <ECDH KEY>. The function result may be any result based on the requested function, e.g., verification of the card.

At 1258, the validator 1288 may return the function result to the switchboard system 1000. In some instances, the function result is returned encrypted. For example, the validator 1288 may return the <ENCRYPTED FUNCTION RESULT> and the <ISSUER EC PUBLIC KEY>.

FIG. 12C continues the sequence 1200 from FIG. 12B. In embodiments, at 1260 the switchboard system 1000 sends the function result to the client server 1284 to process the result. In one example, the switchboard system 1000 may send the <ENCRYPTED FUNCTION RESULT>, <KEY ID>, <ISSUER EC PUBLIC KEY>, and <SIGNED SESSION TOKEN>. At 1262 and 1264, the client server 1284 may make a request for and receive the public key from the switchboard system 1000. In some instances, the exchange may be performed via out-of-band communication channels. The public key for the node may be <NODE PUBLIC KEY>. The public key may be used to verify the sender of the function result, etc. At 1266, the client server 1284 may verify the signed session key with the node's public key <NODE PUBLIC KEY> to verify the sender of the information. At 1268, the client server 1284 may extract client information from the signed session token. For example, the client server 1284 may Extract <CLIENT SESSION INFO> from <SIGNED SESSION TOKEN>, i.e., extracting the client implementation-specific user session identification information.

Further, at 1270, the client server 1284 may retrieve the client's private key with the KEY ID. Specifically, the client server 1284 may get and remove the <CLIENT PRIVATE KEY> from cache using the <KEY ID>. At 1272, the client server 1284 may generate or compute the ECDH key. For example, the client server 1284 may compute the <ECDH KEY> with the <CLIENT PRIVATE KEY>+<ISSUER EC PUBLIC KEY>. The client server 1284 may decrypt the function result with the computed key at 1274. Specifically, the client server 1284 may decrypt the <ENCRYPTED FUNCTION RESULT> with the <ECDH KEY> to determine the <FUNCTION RESULT>. At 1276, the client server 1284 associates the function result with the session.

In embodiments, the switchboard system 1008 may return whether the function result was successfully completed or not at 1278 to the client SDK 1292. Further at 1280, the client SDK 1292 may notify the client app 1290 of the result. At 1282, the client app 1290 may utilize the feature. For example, the 1282 may communicate with the client server 1284 to continue the feature using the <CLIENT SESSION INFO> to fetch the redacted <FUNCTION RESULT>.

FIG. 13 illustrates an example of a message 1300 that may be communicated by a contactless card to perform the functions described herein, such as those discussed in FIG. 12A through FIG. 12C. One or more of the fields in message 1300 may also be utilized to route the message 1300 through the switchboard system and perform authentication/validation techniques.

In embodiments, the message 1300 includes an applet version 1302 field, an issuer discretionary indicator 1304 field, an Issuer Identifier 1306 field, a pKey ID 1308 field, a pUID 1310 field, a pATC 1312 field, a nonce 1314 field, and an encrypted cryptogram 1316.

In embodiments, the fields may be in plain text or encrypted. For example, the applet version 1302 field may include an applet version in plain text. The applet version indicates which applet version is installed on a contactless card and may be used by the other systems to determine how to process the message 1300 when communicated. For example, different Applet versions require different validation logic, e.g., an older message may be routed through the issuer system to perform various operations for validation, while a newer message may be routed through the switchboard system to perform the various operations, including validation.

In embodiments, the message 1300 includes an issuer discretionary indicator 1304 field that may include issuer data and set at the time of personalization. In addition, the message 1300 includes an Issuer Identifier 1306 field that may include a unique ID assigned to the entity issuing the card, e.g., the issuer. For example, when joining the system, each issuer may be assigned a unique identifier during an onboarding operation. The issuer ID can be used by the switchboard system 1008 to route a message and its contents to the appropriate services that are associated with that particular issuer.

In embodiments, the message 1300 includes a pKey ID 1308 field. In some instances, the pKey ID 1308 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each contactless card 602 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described herein.

The message 1300 may include a pUID 1310 field, including a card unique identifier assigned to the contactless card at personalization time. The pUID 1310 field data may be a combination of alphanumeric characters used to identify each card and associated with a user uniquely.

In embodiments, the message 1300 includes a pATC 1312 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 1300 is created, a new session key is derived and utilized to generate one or more portions of the message 1300. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 1300 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 602 may communicate a message between a device, such as a mobile device, during a read operation. For example, in response to the contactless card 602 being tapped onto a surface of the device, e.g., brought within wireless communication range, a read operation may be performed on the contactless card 602, and the contactless card 602 may generate and provide the message to the device. For example, once within range, the contactless card 602 and the device may perform one or more exchanges for the contactless card 602 to send the message to the device.

The wireless communication may be in accordance with a wireless protocol, such as near-field communication (NFC), Bluetooth, WiFi, and the like. In some instances, a message may be communicated between a contactless card 602 and a device via wired means, e.g., via the contact pad, and in accordance with the EMV protocol.

As discussed above, the contactless card 602 may be deployed with a unique card key, e.g., the UDK, that is generated from an issuer's master key and is used to generate session keys. The following discusses the generation of the UDK and the session keys (ASK) and (DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card 602. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacturer, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc, may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card 602 stores the generated application key(s) or UDK(s).

In embodiments, the contactless card 602 utilizes the application key(s) or UDK(s) to generate session keys for each encrypted data is generated. The following is one processing flow that may be performed by the contactless to generate a unique cryptogram session key (ASK).

To generate the ASK, the contactless card 602 computes SKL by encrypting [ATC[2]∥ATC[3]∥‘F0’∥‘00’∥[ATC[0]∥[ATC[1]∥[ATC[2]∥[ATC[3]] with an application key. Further, the contactless card 602 computes SKR by encrypting [ATC[2]∥ATC[3]∥‘0F’|‘00’∥[ATC[0]∥[ATC[1]∥[ATC[2]∥[ATC[3]] with the application key. Finally, the contactless card 602 concatenates SKL with SKR to form an authentication session key (ASK). In embodiments, the ASK is used to perform operations utilizing the contactless card 602, such as encrypting the cryptographic MAC.

In embodiments, the contactless card 602 also supports session key derivation to generate a unique encipherment session key DESK. The contactless card 602 computes an SKL by encrypting [ATC[2]∥ATC[3]∥‘F0’∥‘00’|‘00’|‘00’|‘00’|‘00’] with a Data Encryption Kcy (DEK) or UDK. Further, the contactless card 602 computes SKR by encrypting [ATC[2]∥ATC[3]∥‘0F’|‘00’∥‘00’∥‘00’|‘00’|‘00’] with the DEK or UDK. The contactless card 602 concatenates SKL with SKR to form the Data Encipherment Session Key (DESK).

In embodiments, the contactless card 602 generates encrypted data or a cryptogram utilizing the session keys. Specifically, the contactless card 602 generates a cryptogram C by calculating a MAC over the 32-byte transaction data T using the Authentication Session Key (ASK).

The contactless card 602 may process the data to generate the cryptogram. Specifically, the contactless card 602 divides T into four blocks of 8 bytes of data: T=T1|T2|T3|T4. The contactless card 602 computes B=DES (ASKL) [T1], where is the Data Encryption Standard or another symmetric encryption algorithm, ASKL is a portion of the ASK, e.g., the “left” half of the key. The contactless card 602 computes B=[B XOR T2], and, the contactless card 602 computes B=DES (ASKL) [B], where DES is an encryption algorithm. The contactless card 602 computes B=[B XOR T3], and the contactless card 602 computes B=DES (ASKL) [B]. The contactless card 602 computes B=[B XOR T4], and the contactless card 602 computes B=DES (ASKL) [B]. The contactless card 602 computes B=DES⁻¹ (ASKR) [B], where DES⁻¹ is the reciprocal DES operation, and ASKR is a portion of the ASK, e.g., the right half. The contactless card 602 computes the cryptogram C=DES (ASKL) [B].

In embodiments, a contactless card 602 may also encipher the cryptogram to secure the data further. For example, a contactless card 602 may generate an 8-byte random number [RND] and the card computes E1=DES3(DESK) [RND], where DES3 is a symmetric encryption algorithm such as the Triple Data Encryption Standard. The contactless card 602 then computes B=[E1] XOR [C], where C is the cryptogram generated, as discussed above. The contactless card 602 computes E2=DES3(DESK) [B], where B is computed above. Further, the contactless card 602 generates the 16-byte enciphered payload E=[E1]∥[E2].

In embodiments, a device or the contactless card 602 may decrypt the payload E by determining, receiving, or retrieving the payload E. The device computes a RND=DES3⁻¹(DESK) [E1]. The device determines B=DES3⁻¹(DESK) [E2], and the device computes C=[E1] XOR [B].

In embodiments, the contactless generates or calculates a message authentication code (MAC). In some instances, the MAC may be an updated MAC. In embodiments, the updated MAC is included in data communicated from a contactless card 602 to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes)|Update Date Time (8 bytes)|‘80’|‘00 00 00 00 00’]. For the calculations, the data may be divided into two separate portions. Specifically, the data U is broken into two blocks of 8 bytes of data, where U=U₁∥U₂. Further, operations may be performed on U₁ and U₂.

Embodiments include applying an algorithm to the first portion (U₁) of the data. In one example, a result B may be computed where B=DES (MCKL) [U1], where DES is a Data Encryption Standard algorithm using a first portion (L) of the MAC Card Key (MCKL).

Further, an additional operation may be performed on the result B. Specifically, the result B may be exclusively or'd (XOR) with a second portion of the data (U₂).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

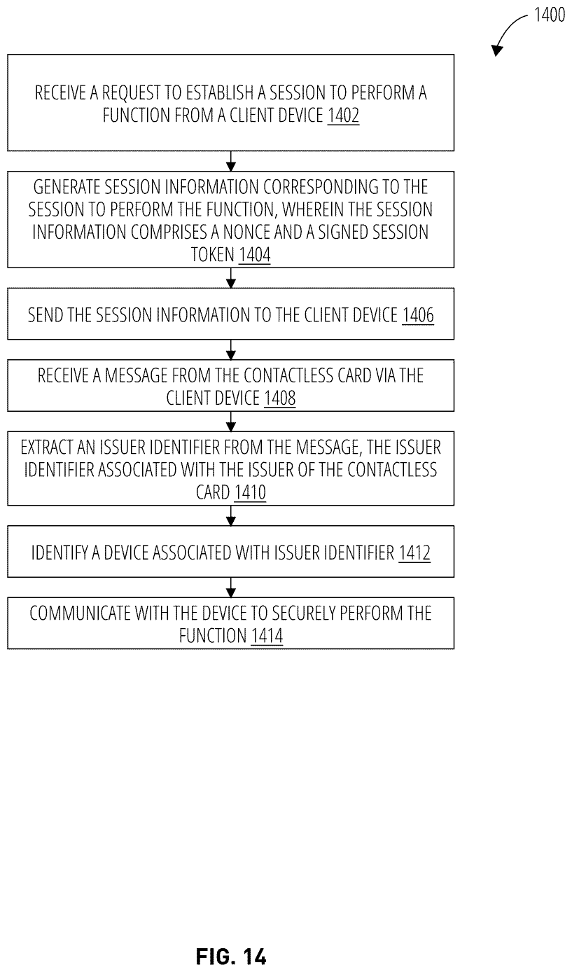

FIG. 14 illustrates an example of method 1400 in accordance with embodiments discussed herein. In block 1402, the method 1400 includes receiving, by a node in a system, a request to establish a session to perform a function from a client device, wherein the function is at least partially performed utilizing a contactless card, such as contactless card 602. In some instances, the node may be one of a plurality nodes of a switchboard system. The node may be previously selected by the sending device via a DNS operation performed.

In block 1404, the method 1400 includes generating, by the node, session information corresponding to the session to perform the function, wherein the session information comprises a nonce and a signed session token. The nonce and/or signed session token may be utilized by systems to perform the functions described herein while ensuring the node routing the data is authenticated, the message from the contactless card is authenticated, and to keep track of the session for the function.

In block 1406, method 1400 includes sending the session information to the client device by the node. The client device may communicate with a contactless card to receive data from the card to authenticate and perform a function. In some instances, the client device may send the nonce from the node to the contactless card. The contactless card may utilize the nonce when generating the message to communicate back to the client device. Finally, the node, e.g., incorporates it into a cryptographic portion of the message (see FIG. 13).

In block 1408, method 1400 includes receiving, by the node, a message from the contactless card via the client device. The message may be generated by the contactless card. FIG. 13 illustrates one example of a message 1300. In some embodiments, the node verifies the message. For example, the node may verify a nonce in the message and a signed session token.

In block 1410, method 1400 extracts an issuer identifier from the message by the node, the issuer identifier associated with the issuer of the contactless card. In some instances, the issuer identifier may be in a plaintext format.

In block 1412, method 1400 identifies, by the node, a device associated with the issuer identifier. For example, the node may perform a lookup to determine a server associated with the issuer identifier and the function to be performed.

In block 1414, method 1400 communicates, by the node, with the device to securely perform the function.

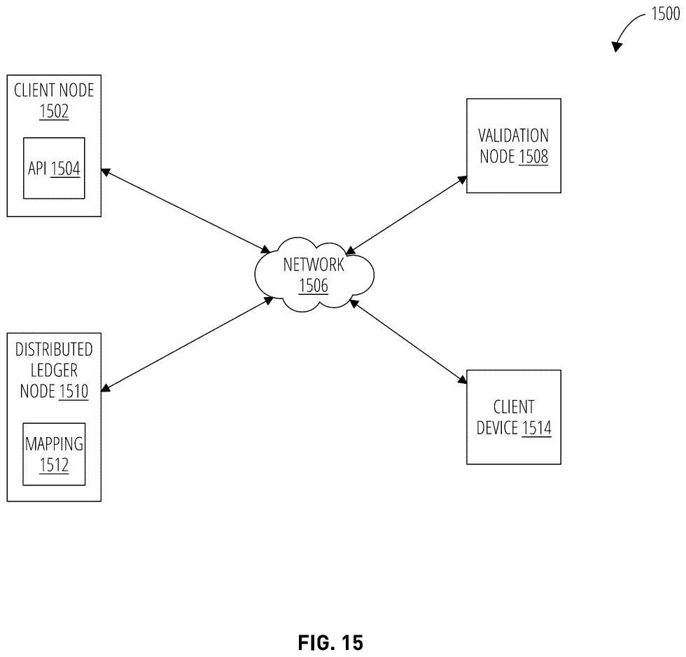

FIG. 15 illustrates a distributed network authentication system 1500 according to an example embodiment. As further discussed below, system 1500 can include client node 1502, API 1504, network 1506, distributed ledger node 1510, mapping 1512, and client device 1514. Although FIG. 15 illustrates single instances of the components, system 1500 can include any number of components.

System 1500 can include a client node 1502, which can be a network-enabled computer as described herein. In some examples, client node 1502 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1500.

In some examples, client node 1502 can execute one or more applications, such as software applications, that enable, for example, network communications with one or more components of system 1500, transmit and/or receive data, and perform the functions and processes described herein.

The client node can contain an API 1504. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 1504 to interact with the service, such as by performing a remote call to an API for interacting with a web-based service.

API 1504 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 1502 can communicate with one or more other components of system 1500 either directly or via network 1506. Network 1506 can comprise one or more of a wireless network, a wired network or any combination of wireless network and wired network, and may be configured to connect the components of system 1500. While FIG. 15 illustrates communication between the components of system 1500 through network 1506, it is understood that any component of system 1500 can communicate directly with another component of system 1500, e.g., without involving network 1506.

System 1500 can include a validation node 1508, which can be a network-enabled computer as described herein. In some examples, validation node 1508 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1500.

In some examples, validation node 1508 can execute one or more applications, such as software applications, that enable, for example, network communications with one or more components of system 1500, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1500 can include a distributed ledger node 1510, which can be a network-enabled computer as described herein. In some examples, distributed ledger node 1510 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1500.

In some examples, distributed ledger node 1510 can execute one or more applications, such as software applications, that enable, for example, network communications with one or more components of system 1500, transmit and/or receive data, and perform the functions and processes described herein.

Distributed ledger node 1510 can containing a mapping 1512. In some examples, mapping 1512 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1500, or the one or more databases can be hosted externally to any component of the system 1500. In some examples, the one or more databases can be contained in the distributed ledger node 1510, and in other examples the one or more databases can be stored outside of distributed edger node 1510 but in data communication with distributed ledger node 1510. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 1510. In other examples, the one or more databases can be remote from distributed ledger node 1510 but in data communication with distributed ledger node 1510. Data communication between the one or more databases and distributed ledger node 1510 can be a direct data communication or data communication via a network, such as the network 1506.

In some examples, client node 1502 can be in data communication with distributed ledger node 1510. Distributed ledger node 1510 can contain mapping 1512. Mapping 1514 may include, e.g., a mapping between a validation node address and the validation node 1508, a mapping between a routing number and a validation node address, and/or a mapping between a routing number and validation node 1508. In some examples, mapping 1512 can include a digital signature associated with an entity having permission to validate for a routing number. Based on one or more of these associations, client node 1502 can call validation node for validation and/or provide direction to the client device to reach the appropriate validation node. This can be accomplished by calling a validation API associated with validation node 1508.

In some examples, iterations of the mappings described herein, such as mapping 1512, can also include a software or applet version number. The version number can be used to identify a validation node or validation node address or choose between multiple validation addresses for one validation node.

In some examples, client node 1502 and distributed ledger node 1510 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 1510 can update mapping 1512 to reflect a different association between, e.g., a routing number, a validation node address, and a validation node. In some examples, degrees of permissions can be issued. For example, if client node 1502 were to function to route data to validation node 1508 (or other validation nodes), client node 1502 can be given a certain level of permissions. As another example, if distributed ledger node 1510 were to have the capability to update mapping 1512, distributed ledger node 1510 can have a different, higher level of permissions.

System 1500 can include a client device 1514, which can be a network-enabled computer as described herein. In some examples, distributed ledger node 1514 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1500. Client device 1514 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 1514 can be in data communication with another network-enabled computer not shown in FIG. 15, such as a smart card (e.g., a contactless card or a contact-based card).

In some examples, client device 1514 can execute one or more applications, such as software applications, that enable, for example, network communications with one or more components of system 1500, transmit and/or receive data, and perform the functions and processes described herein.

In some examples, upon receipt of an authentication request, client device 1514 can call (e.g., via an API) client node 1502. The call can include a routing number and/or an applet or software version number, and client node 1502 can query distributed ledger node 1510 and mapping 1512. Once the query returns the identification of a validation node (e.g., validation node 1508) and/or a validation node address associated with that routing number and/or applet or software version, client node 1502 can reply to client device 1514. Client device 1514 can then proceed with authentication with the validation node. The authentication can be performed by, e.g., the systems and methods described herein, such as by the generation, encryption, transmission, decryption, and validation of a cryptogram as described herein.

In some examples, client node 1502 can be co-resident with validation node 1508. In these examples, client node 1502 can handle the authentication in a single call from client device 1514. In some examples, this can be acceptable only if it is permissible for the full authentication transmission (e.g., a cryptogram as described herein) to be sent to client nodes that are not involved in authentication.

In some examples, if client node 1502 receives, from client device 1514, a routing number that is not handled by its location, client node 1502 can return a code indicating that this routing number is not handled, along with validation node address for the responsible validation node. Client device 1514 can then send the full authentication transmission to validation node 1508 using the received validation node address.

In some examples, client node 1502 can enter the distributed network with different permissions. For example, client node 1502 can be a read-only router of data. As another example, client node 1502 can have permission to send messages to distributed ledger node 1510 updating one or more routing paths for one or more routing numbers. However, client node 1502 would be prevented from updating one or more routing paths for one or more routing numbers for other entities that control other routing numbers which are not associated with client node 1502 or that did not grant this permission. As another example, distributed ledger node 1510 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client node 1502, distributed ledger node 1510, and/or validation node 1508, if security, legal, and/or financial conditions are met, however, delegation is not required.

In some examples, one or more APIs can facilitate communication between components of system 1500 via network 1506. In other examples, one or more APIs are not required. Rather, the components of system 1500 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 1508 for authentication, can require storage of the keys in one or more HSMs, to promote key security and ensure that the keys are never entered into memory.

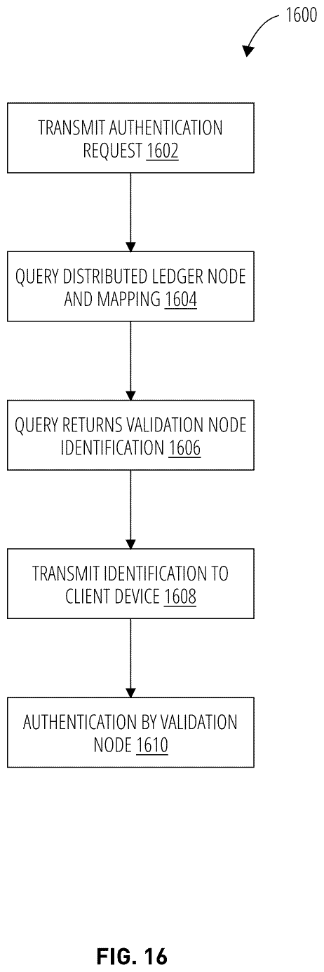

FIG. 16 illustrates a method 1600 performed by a distributed network authentication system according to an example embodiment. For example, the method can be performed by distributed network authentication system 1500 and or by another distributed network authentication system.

In block 1602, a client device can transmit an authentication request to a client node. The authentication request can include, without limitation, a routing number, a software version number, and/or an applet version number. The request can be made by an API call or other communication between the client device and the client node.

In block 1604, after receiving the authentication request, the client node can transmit a query (e.g., via an API call) to a distributed ledger node. The distributed ledger node contain a mapping, and the distributed ledger node can submit the query to the mapping.

In block 1606, the query can return an identification of a validation node and/or a validation node address, and the distributed ledger node can transmit this identification to the client node.

In block 1608, the client node can transmit the identification to the client device. After receiving the identification, the client device can proceed with authentication with the identified validation node and/or validation node address, in block 1610.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed:

1. A computer-implemented method, comprising:
authenticating, using at least one processor, a user login information associated with using at least one digital service in a plurality of digital services, the authenticating including verifying the user login information with the at least one digital service, and storing the verified user login information;
generating, using the at least one processor, a cryptogram including the verified user login information; and
providing, using the at least one processor, the generated cryptogram including the verified user login information to a contactless card communicatively coupled to the at least one processor, and causing the generated cryptogram to be stored in a memory location of the contactless card;
wherein the generated cryptogram is configured to automatically authenticate the user login information for accessing the at least one digital service using the contactless card.

2. The method according to claim 1, wherein the generated cryptogram is configured to include a plurality of user login information, each user login information in the plurality of user login information being associated with a respective digital service in the plurality of digital services.

3. The method according to claim 1, further comprising
generating an updated cryptogram, the updated cryptogram including at least one of the following: a verified updated user login information associated with the at least one digital service, another verified user login information associated with at least another digital service in the plurality of digital services, and any combination thereof; and
providing the updated cryptogram to the contactless card and causing the updated cryptogram to be stored in the memory location of the contactless card.

4. The method according to claim 1, wherein the verifying includes verifying the user login information using at least one of: a multi-factor authentication, a biometric information of the user associated with the login information, and any combination thereof.

5. The method according to claim 1, further comprising
selecting, using the at least one processor, the at least one digital service for accessing;
generating, using the at least one processor, a user interface associated with the selected at least one digital service;
receiving, using the at least one processor, via the generated user interface, the user login information associated with the at least one digital service;
transmitting, using the at least one processor, the received user login information to the at least one digital service; and
executing the authenticating of the user login information.

6. The method according to claim 1, further comprising
receiving, using the at least one processor, the stored verified user login information from the contactless card; and
automatically accessing, using the at least one processor, the at least one digital service using the stored verified user login information.

7. The method according to claim 6, wherein the automatically accessing includes generating a digital service user interface associated with the at least one digital service while bypassing the authenticating, wherein the digital service user interface is configured to enable access to one or more secure digital services associated with the at least one digital service.

8. The method according to claim 1, wherein the at least one digital service includes at least one of the following: a website, a mobile application, and any combination thereof.

9. A contactless card, comprising
at least one processor; and
at least one non-transitory storage media storing instructions, that when executed by the at least one processor, cause the at least one processor to perform operations including
receiving and storing a cryptogram, the cryptogram including a verified user login information, the verified user login information being generated by authenticating a user login information associated with using at least one digital service in a plurality of digital services by verifying the user login information with the at least one digital service; and
automatically authenticating, using the cryptogram, the user login information for accessing the at least one digital service.

10. The contactless card according to claim 9, wherein the generated cryptogram is configured to include a plurality of user login information, each user login information in the plurality of user login information being associated with a respective digital service in the plurality of digital services.

11. The contactless card according to claim 9, wherein the operations further comprise
receiving and storing an updated cryptogram, the updated cryptogram including at least one of the following: a verified updated user login information associated with the at least one digital service, another verified user login information associated with at least another digital service in the plurality of digital services, and any combination thereof; and
automatically authenticating, using the updated cryptogram, the user login information for accessing the at least one digital service.

12. The contactless card according to claim 9, wherein the verifying includes verifying the user login information using at least one of: a multi-factor authentication, a biometric information of the user associated with the login information, and any combination thereof.

13. The contactless card according to claim 9, wherein the operations further comprise
receiving a selection of the at least one digital service for accessing;
causing generation of a user interface associated with the selected at least one digital service;
identifying the stored verified updated user login information associated with the selected at least one digital service;
transmitting the identified stored verified user login information; and
causing automatic access to the at least one digital service using the stored verified user login information.

14. The contactless card according to claim 13, wherein the causing of the automatic accessing includes triggering generation of a digital service user interface associated with the at least one digital service while bypassing the authenticating, wherein the digital service user interface is configured to enable access to one or more secure digital services associated with the at least one digital service.

15. The contactless card according to claim 9, wherein the at least one digital service includes at least one of the following: a website, a mobile application, and any combination thereof.

16. A system, comprising:
a contactless card
at least one processor communicatively coupled to the contactless card; and
at least one non-transitory storage media storing instructions, that when executed by the at least one processor, cause the at least one processor to perform operations including
selecting, using the at least one processor, at least one digital service for accessing;
generating, using the at least one processor, a user interface associated with the selected at least one digital service;
receiving, using the at least one processor, via the generated user interface, a user login information associated with the at least one digital service;
transmitting, using the at least one processor, the received user login information to the at least one digital service;
authenticating, using the at least one processor, the received user login information associated by verifying the received user login information with the at least one digital service, and storing the verified user login information;
generating, using the at least one processor, a cryptogram including the verified user login information; and
providing, using the at least one processor, the generated cryptogram including the verified user login information to the contactless card, and causing the generated cryptogram to be stored in a memory location of the contactless card;
automatically authenticating, using the contactless card, the user login information for accessing the at least one digital service using the contactless card.

17. The system according to claim 16, wherein the generated cryptogram is configured to include a plurality of user login information, each user login information in the plurality of user login information being associated with a respective digital service in the plurality of digital services.

18. The system according to claim 16, wherein the verifying includes verifying the user login information using at least one of: a multi-factor authentication, a biometric information of the user associated with the login information, and any combination thereof.

19. The system according to claim 16, wherein the operations further comprise
receiving a selection of the at least one digital service for accessing;
causing generation of a user interface associated with the selected at least one digital service;
identifying the stored verified updated user login information associated with the selected at least one digital service;
transmitting the identified stored verified user login information; and
causing automatic access to the at least one digital service using the stored verified user login information by triggering generation of a digital service user interface associated with the at least one digital service while bypassing the authenticating, wherein the digital service user interface is configured to enable access to one or more secure digital services associated with the at least one digital service.

20. The system according to claim 16, wherein the at least one digital service includes at least one of the following: a website, a mobile application, and any combination thereof.
